(19) United States
(12) Patent Application Publication
(10) Pub. No.: US 2026/0088522 A1
(43) Pub. Date: Mar. 26, 2026

(54) RF MIMO Communication System with Signal Restructuring

(71) Applicant: MEDIATEK INC., Hsinchu City (TW)

(72) Inventor: Chung-Hsin Chiang, Hsinchu City (TW)

(73) Assignee: MEDIATEK INC., Hsinchu City (TW)

(21) Appl. No.: 19/313,803

(22) Filed: Aug. 28, 2025

Related U.S. Application Data
(60) Provisional application No. 63/698,096, filed on Sep. 24, 2024.
(60) Provisional application No. 63/698,099, filed on Sep. 24, 2024.

(51) Int. Cl. H01Q 25/02; H01P 5/22; H04B 7/0413

(52) U.S. Cl. CPC H01Q 25/02; H01P 5/222; H04B 7/0413

(57) ABSTRACT

A signal restructure unit for radio frequency (RF) antenna systems includes four ports and a signal routing circuit. The signal routing circuit receives RF signals at input ports and provides phase-controlled outputs to antenna ports. When receiving sum signals, the unit provides in-phase restructured signals for common-mode antenna operation. When receiving difference signals, the unit provides anti-phase restructured signals for differential-mode antenna operation. The signal routing circuit may be implemented as a rat-race coupler with transmission line segments or as discrete circuit elements including inductors and capacitors. An RF communication system incorporates the signal restructure unit with digital processing circuits, transceivers, and antennas to achieve MIMO operation from a single antenna structure. The system provides improved isolation while reducing the antenna size. The restructure unit enables reconfigurable MIMO operation with enhanced performance for wireless communication applications.

### CROSS REFERENCE TO RELATED APPLICATIONS

This application claims the benefit of U.S. Provisional Application No. 63/698,096, filed on Sep. 24, 2024. Further, this application claims the benefit of U.S. Provisional Application No. 63/698,099, filed on Sep. 24, 2024. The contents of these applications are incorporated herein by reference.

### BACKGROUND

Multiple-input multiple-output (MIMO) technology has become essential in modern wireless communication systems to achieve higher data rates and improved spectral efficiency. MIMO systems utilize multiple antennas to transmit and receive spatially separated data streams simultaneously, creating uncorrelated signal paths that enable increased throughput without requiring additional bandwidth or transmit power. Conventional MIMO antenna systems typically employ multiple physically separated antennas to generate uncorrelated signals. These traditional methods include: spatial diversity MIMO and polarization diversity MIMO. However, conventional MIMO antenna implementations suffer from several significant drawbacks including size constraints, poor isolation and integration challenges.

Current solutions fail to address these needs adequately, particularly for emerging applications such as 5G and upcoming 6G communications, IoT devices, and other space-constrained wireless systems where traditional multi-antenna MIMO techniques are impractical. Therefore, there exists a need for an improved MIMO antenna system that can generate uncorrelated signals from a single antenna structure while providing superior isolation, reduced size, and simplified implementation compared to conventional multi-antenna approaches.

### SUMMARY

An embodiment provides a signal restructure unit for a radio frequency (RF) antenna system. The signal restructure unit includes a first port coupled to an antenna, a second port capable of receiving second RF signals, a third port coupled to the antenna, and a fourth port capable of receiving first RF signals. The signal restructure unit further includes a signal routing circuit coupled to the fourth port, the second port, the first port and the third port. The signal routing circuit is capable of providing in-phase restructured signals to the first port and third port when the second RF signals comprise a sum signal, and providing anti-phase restructured signals to the first port and third port when the first RF signals comprise a difference signal.

In certain aspects, the signal routing circuit comprises a rat-race coupler. In further aspects, the rat-race coupler comprises at least one quarter-wavelength (λ/4) segment and at least one three-quarter-wavelength (3λ/4) segment.

In certain aspects, the signal routing circuit comprises a first inductive element coupled between the first port and the second port, a second inductive element coupled between the first port and the fourth port, a third inductive element coupled between the second port and the third port, a first capacitive element coupled between the third port and the fourth port, a second capacitive element coupled between the first port and a ground, a third capacitive element coupled between the second port and the ground, and an impedance element coupled to each of the first port, the second port, the third port and the fourth port. The first, second, and third inductive elements have substantially equal inductance, and the second and third capacitive elements each have a capacitance approximately twice that of the first capacitive element.

In certain aspects, the signal routing circuit comprises a substrate, a plurality of conductive traces forming a double octagonal ring configuration coupling the fourth port, the second port, the first port, and the third port, and a plurality of overlapping regions, each having corresponding conductive traces disposed in different layers.

In certain aspects, the antenna comprises various configurations including vertical radiating elements with horizontal feeding elements, L-shaped radiating structures with opposing arms and symmetrical arrangements, multi-layer configurations with overlapping structures, and F-shaped radiating structures with multiple arms.

Another embodiment provides a radio frequency (RF) communication system. The RF communication system includes a digital processing circuit capable of generating and processing baseband signals, a first transceiver coupled to the digital processing circuit and capable of converting the digital baseband signals to first RF signals and converting received first RF signals to digital baseband signals, and a second transceiver coupled to the digital processing circuit and capable of converting the digital baseband signals to second RF signals and converting received second RF signals to digital baseband signals. The system further includes a signal restructure unit coupled to the first transceiver and the second transceiver, and capable of receiving first RF signals from the first transceiver and second RF signals from the second transceiver, and outputting restructured RF signals having at least one of in-phase relationship or anti-phase relationship. An antenna is coupled to the signal restructure unit and capable of radiating the restructured RF signals and receiving incoming RF signals.

In certain aspects, the signal restructure unit comprises a first port coupled to the antenna, a second port capable of receiving the second RF signals from the second transceiver, a third port coupled to the antenna, a fourth port capable of receiving the first RF signals from the first transceiver, and a signal routing circuit coupled to the fourth port, the second port, the first port and the third port. The signal routing circuit is capable of providing in-phase restructured signals to the first port and third port when the second RF signals comprise a sum signal, and providing anti-phase restructured signals to the first port and third port when the first RF signals comprise a difference signal.

In certain aspects, the digital processing circuit comprises a data processor capable of processing digital data, a modulator coupled to the data processor and capable of modulating the digital data into the digital baseband signals, a spatial processor capable of processing spatial diversity signals, a demodulator coupled to the spatial processor and capable of demodulating received digital baseband signals into digital data, a detection and acquisition unit capable of detecting and acquiring incoming signals, and a power control unit capable of controlling transmission power levels.

In certain aspects, the digital processing circuit further comprises a main control unit capable of coordinating operation of the data processor, modulator, spatial processor, and demodulator, and a memory unit comprising random access memory (RAM) and read-only memory (ROM). The main control unit is capable of executing control algorithms stored in the memory unit.

In certain aspects, the first transceiver and the second transceiver each comprise a transmitter unit capable of converting digital baseband signals to respective RF signals, and a receiver unit capable of converting received RF signals to digital baseband signals. In certain aspects, the transmitter unit and the receiver unit implement a direct-conversion architecture.

In certain aspects, the transmitter unit comprises a digital-to-analog converter (DAC) capable of converting the digital baseband signals to analog baseband signals, a filter coupled to the DAC and capable of filtering the analog baseband signals, an amplifier coupled to the filter and capable of amplifying the filtered analog baseband signals, a mixer coupled to the amplifier and capable of converting the amplified baseband signals using a transmit local oscillator signal, a power amplifier (PA) coupled to the mixer and capable of amplifying the converted signals to generate the respective RF signals, and an RF switch coupled between the power amplifier and the signal restructure unit.

In certain aspects, the signal restructure unit is positioned between the mixers and power amplifiers in the transmitter units of the first and second transceivers, and is capable of receiving signals from the mixers of the first and second transceivers and providing phase-controlled signals to the power amplifiers of the first and second transceivers.

In certain aspects, the signal restructure unit is positioned between the amplifiers and mixers in the transmitter units of a first transceiver and a second transceiver, and is capable of receiving signals from the amplifiers of the first and second transceivers and providing phase-controlled signals to the mixers of the first and second transceivers.

In certain aspects, the receiver unit comprises an RF switch coupled between the signal restructure unit and the low noise amplifier (LNA), a low noise amplifier capable of amplifying received incoming RF signals, a mixer coupled to the LNA and capable of converting the amplified RF signals using a receive local oscillator signal, a filter coupled to the mixer and capable of filtering the converted signals, an amplifier coupled to the filter and capable of amplifying the filtered signals, and an analog-to-digital converter (ADC) coupled to the amplifier and capable of converting the amplified analog signals to digital baseband signals.

The signal restructure unit and RF communication system enhance the isolation between MIMO signal paths. By integrating signal restructuring, the overall antenna size can be minimized. The reconfigurable operation allows the system to adapt to varying channel conditions and diverse system requirements.

To the accomplishment of the foregoing and related ends, certain embodiments comprise the features hereinafter fully described and particularly pointed out in the claims. The following description and accompanying drawings set forth in detail certain illustrative aspects of the embodiments. These aspects are indicative, however, of but a few of the various ways in which the principles of the embodiments may be employed, and the present disclosure is intended to include all such aspects and their equivalents. These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1A to 1B depict signal restructure units for MIMO antenna systems according to embodiments of the present invention

FIG. 2 depicts a signal restructure unit according to an embodiment, showing a rat-race coupler implementation with transmission line segments.

FIGS. 3A to 3C depict a signal restructure unit according to alternative embodiments of the present invention, showing discrete circuit elements with switching capabilities for bypass mode and active mode operations.

FIG. 4 depicts a signal restructure unit according to an embodiment of the present invention, showing an integrated circuit implementation using FD-SOI CMOS technology.

FIGS. 5A to 5F depict various antenna configurations that can be utilized with the signal restructure unit according to different embodiments.

FIGS. 6 to 8 depict RF communication systems according to embodiments of the present invention, showing complete MIMO communication systems with different positioning of signal restructure units within the RF signal chain.

FIGS. 9A to 9B depict TX and RX signal restructure units according to embodiments of the present invention, showing digital processing circuits for baseband signal restructuring operations.

FIGS. 10 to 11 depict RF communication systems according to embodiments of the present invention, showing complete MIMO communication systems incorporating TX and RX signal restructure units respectively.

FIGS. 12 to 13 depict flow diagrams showing methods of operating radio frequency communication systems for MIMO communication according to embodiments of the present invention.

### DETAILED DESCRIPTION

Radio frequency (RF) multiple-input multiple-output (MIMO) antenna systems typically rely on multiple physically separated antennas to produce uncorrelated signals. One common technique is spatial diversity MIMO, where antennas are placed at different physical locations, usually spaced at least half a wavelength (λ/2) apart to ensure signal decorrelation. While effective, this method demands considerable physical space, posing challenges for integration into compact devices like smartphones, tablets, and IoT hardware. Another method, polarization diversity MIMO, uses antennas with orthogonal polarizations on the same structure, e.g., vertical and horizontal or left-hand and right-hand circular polarization. Although this reduces the need for physical separation, it often requires larger antenna element physical size.

Despite their widespread use, current MIMO systems face several limitations. Size constraints are a major issue, as the need for multiple antenna elements with adequate spacing can lead to total antenna dimensions reaching a full wavelength (λ), which is impractical for 5G and upcoming 6G communications. Additionally, these systems often suffer from poor isolation, typically achieving only −10 dB to −15 dB between antenna ports, which leads to signal correlation and diminished MIMO performance. Integration challenges also arise due to the need for separate feed networks, matching circuits, and RF switches, increasing system complexity, cost, and power consumption. Furthermore, the routing of multiple RF signal paths introduces additional losses and potential interference. Another drawback is limited reconfigurability, as current MIMO antennas operate in fixed configurations and lack adaptability to changing channel conditions or system requirements.

To enhance MIMO performance, various signal processing techniques have been developed. Beamforming uses digital algorithms to adjust the phase and amplitude of signals across antenna elements to create directional radiation patterns, though it still requires multiple physical antennas and complex processing. Space-time coding improves reliability and throughput by distributing data across multiple antennas and time slots, but it does not resolve the fundamental issues of antenna size and isolation. Channel State Information (CSI) feedback allows systems to adapt transmission parameters based on channel measurements, improving performance but adding complexity and overhead to the communication protocol.

Manufacturing and implementation challenges further complicate the current MIMO systems. The process involves precise mechanical alignment and individual tuning of multiple antennas, increasing complexity and cost. Performance can vary due to differences in antenna spacing, orientation, and manufacturing tolerances, affecting reliability. Moreover, integrating these systems with electronics requires extensive RF routing between antennas and transceivers, which limits integration possibilities and raises concerns about electromagnetic interference (EMI).

Given the limitations of the current MIMO antenna systems, there is a clear and pressing need for improved solutions that address the performance and integration challenges. Future innovations should focus on reducing the overall antenna size without compromising MIMO performance, enabling more compact and efficient designs suitable for high-frequency applications such as 5G and beyond. Enhancing isolation between MIMO signal paths is also necessary to minimize signal correlation and maximize data throughput. Additionally, simplifying the manufacturing and integration processes can help lower production costs and improve scalability. Reconfigurable operation is another essential feature, allowing systems to dynamically adapt to changing channel conditions and user requirements.

To address the challenges outlined above, the following disclosure presents a detailed description of various embodiments designed to overcome the limitations of the current MIMO antenna systems. While specific implementation details are provided to support a thorough understanding of the proposed solutions, it will be evident to those skilled in the art that the invention may be practiced without strict adherence to every particular described herein. In some cases, well-known methods, procedures, components, and circuits have been intentionally omitted to avoid obscuring the essence of the disclosure. Furthermore, it should be understood that technical features described in connection with a single drawing may be implemented individually or in combination with other features, as specified throughout this document.

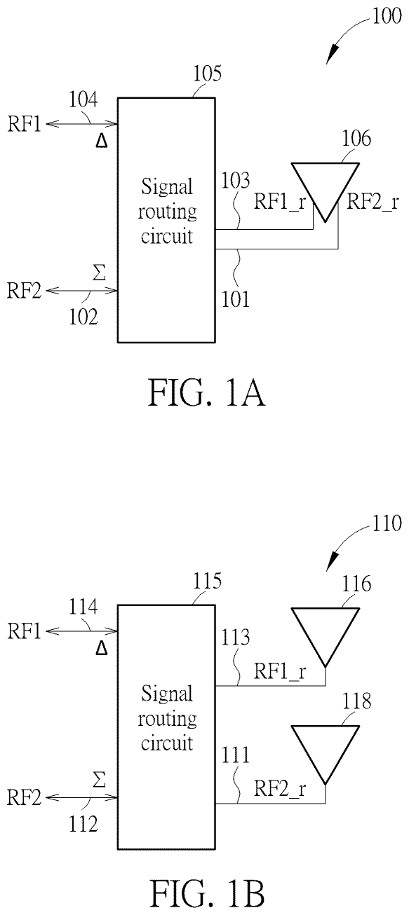

FIG. 1A depicts a signal restructure unit 100 for a MIMO antenna system according to an embodiment of the present invention. The signal restructure unit 100 includes a first port 101, a second port 102, a third port 103, a fourth port 104, and a signal routing circuit 105. The signal routing circuit 105 is coupled to the first port 101, second port 102, third port 103, and fourth port 104. The signal routing circuit 105 is for receiving RF signals and provide phase-controlled outputs to a MIMO antenna 106.

The first port 101 and third port 103 are coupled to a MIMO antenna 106. The first port 101 provides output signals to a first feed point of the MIMO antenna 106, while the third port 103 provides output signals to a second feed point of the MIMO antenna 106. The second port 102 receives an RF signal RF2 having a sum signal (Σ). The fourth port 104 receives an RF signal RF1 having a difference signal (Δ).

The signal routing circuit 105 processes the RF signals RF1 and RF2 to generate controlled phase relationships between the restructured signals RF1_r and RF2_r provided to the first port 101 and third port 103. When the signal routing circuit 105 receives RF signal RF2 with the sum signal (Σ) at the second port 102, it provides restructured signals RF1_r and RF2_r as in-phase outputs to the first port 101 and third port 103, creating a 0° phase relationship between the restructured signals RF1_r and RF2_r. When the signal routing circuit 105 receives RF signal RF1 with the difference signal (Δ) at the fourth port 104, it provides restructured signals RF1_r and RF2_r as anti-phase outputs to the first port 101 and third port 103, creating a 180° phase relationship between the restructured signals RF1_r and RF2_r.

The MIMO antenna 106 operates in different modes based on the phase relationships of the restructured signals RF1_r and RF2_r provided by the signal routing circuit 105. The in-phase restructured signals enable common-mode operation of the MIMO antenna 106, while the anti-phase restructured signals enable differential-mode operation of the MIMO antenna 106. This dual-mode operation provides the MIMO antenna 106 to generate uncorrelated MIMO signals from a single antenna structure.

The signal restructure unit configuration provides certain operational advantages compared to conventional multi-antenna MIMO systems. The single antenna structure with signal restructuring enables a total antenna size of approximately 0.5λ, compared to traditional multi-antenna MIMO systems that typically require λ total size. The signal restructuring methodology achieves isolation levels of approximately −45 dB between MIMO signal paths, compared to approximately −10 dB typically achieved in conventional multi-antenna systems.

The bidirectional operation capability allows the signal restructure unit to function in both transmit and receive modes. During transmit operation, the signal routing circuit 105 receives signals from transceivers and provides phase-controlled outputs to the MIMO antenna 106 for radiation. During receive operation, the signal routing circuit 105 processes signals received from the MIMO antenna 106 and provides appropriate outputs to the transceivers for further processing.

FIG. 1B depicts a signal restructure unit 110 for a MIMO antenna system according to an embodiment of the present invention. Similar to the embodiment of FIG. 1A, the signal restructure unit includes a signal routing circuit 115 and multiple ports. The signal routing circuit 115 is coupled to ports 111-114 and provides phase-controlled outputs to two separate antennas 116 and 118.

The signal restructure unit includes multiple input and output ports for signal processing. The fourth port 114 receives RF signal RF1 having a difference signal (Δ), while the second port 112 receives RF signal RF2 having a sum signal (Σ). These input signals enable the signal restructure unit to generate phase-controlled outputs for driving the dual-antenna configuration.

The signal restructure unit 110 provides RF output signals to the dual-antenna configuration through the output ports. The third port 113 couples to a first antenna 116, while the first port 111 couples to a second antenna 118. The first antenna 116 receives restructured signal RF1_r from the third port 113, and the second antenna 118 receives restructured signal RF2_r from the first port 111. Each antenna can be optimized independently for specific radiation characteristics, frequency bands, or polarization properties.

The signal routing circuit 115 processes the RF signals RF1 and RF2 to generate controlled phase relationships between the restructured signals RF1_r and RF2_r provided to the first port 111 and third port 113. When the signal routing circuit 115 receives RF signal RF2 with the sum signal (Σ) at the second port 112, it provides restructured signals RF1_r and RF2_r as in-phase outputs to the first port 111 and third port 113, creating a 0° phase relationship between the restructured signals RF1_r and RF2_r. When the signal routing circuit 115 receives RF signal RF1 with the difference signal (Δ) at the fourth port 114, it provides restructured signals RF1_r and RF2_r as anti-phase outputs to the first port 111 and third port 113, creating a 180° phase relationship between the restructured signals RF1_r and RF2_r.

The dual-antenna configuration provides several advantages for MIMO operation. The first antenna 116 and second antenna 118 can be spatially separated to achieve desired isolation levels and decorrelation between signal paths. The antennas may be positioned with appropriate spacing, optimized based on the specific application requirements. This configuration can be advantageous in applications where antenna placement allows for multiple antenna elements, or where enhanced isolation and decorrelation are required for optimal MIMO performance.

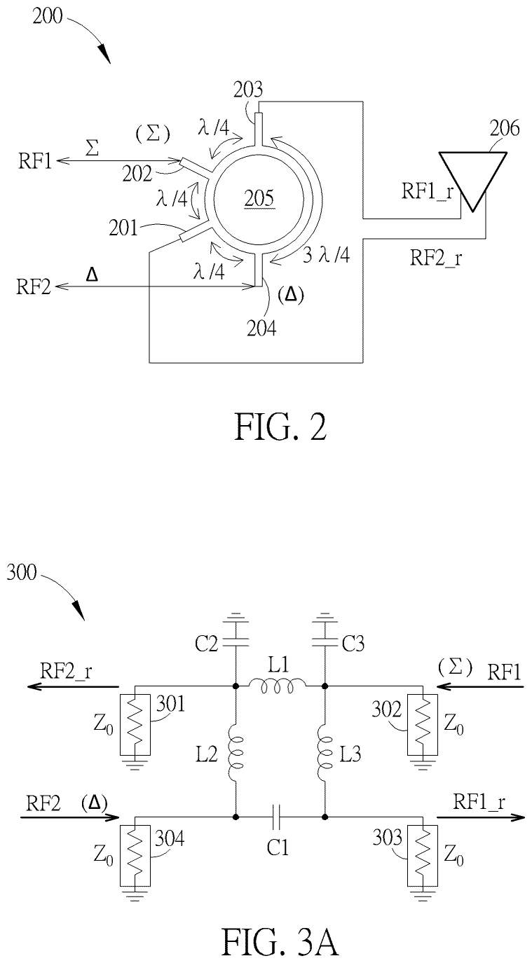

FIG. 2 depicts a signal restructure unit 200 according to an embodiment. The signal restructure unit 200 represents an implementation of the signal restructure unit illustrated in FIGS. 1A and 1B. The signal restructure unit 200 includes a rat-race coupler 205 that implements the signal routing circuit function described in FIGS. 1A and 1B. The rat-race coupler 205 includes transmission line segments arranged in a ring configuration to provide the required phase relationships for MIMO antenna operation.

The signal restructure unit 200 includes a first port 201, a second port 202, a third port 203, and a fourth port 204 positioned around the periphery of the rat-race coupler 205. The second port 202 receives RF signal RF1 having a sum signal (Σ). The fourth port 204 receives RF signal RF2 having a difference signal (Δ). The first port 201 and third port 203 can be output ports that provide restructured signals RF1_r and RF2_r respectively to the MIMO antenna 206.

The rat-race coupler 205 includes transmission line segments with certain electrical lengths. The ring structure can include three quarter-wavelength (λ/4) segments and one three-quarter-wavelength (3λ/4) segment. The quarter-wavelength segments connect adjacent ports around the ring, while the three-quarter-wavelength segment completes the ring structure. This arrangement of transmission line segments can establish the phase relationships necessary for generating in-phase and anti-phase outputs.

When RF signal RF1 having the sum signal (Σ) is applied to the second port 202, the rat-race coupler 205 provides restructured signals RF1_r and RF2_r at the first port 201 and third port 203 with a 0° phase relationship. The signal propagates through the transmission line segments, and the electrical lengths of the λ/4 segments result in equal phase delays to both output ports. This configuration enables common-mode operation of the MIMO antenna 206.

When RF signal RF2 having the difference signal (Δ) is applied to the fourth port 204, the rat-race coupler 205 provides restructured signals RF1_r and RF2_r at the first port 201 and third port 203 with a 180° phase relationship. The electrical lengths of the λ/4 and 3λ/4 segments from the fourth port 204 to both output ports yield the 180° phase difference between the restructured signals. This configuration provides differential-mode operation of the MIMO antenna 206.

The MIMO antenna 206 receives the restructured signals RF1_r and RF2_r from the first port 201 and third port 203 respectively. The antenna 206 radiates electromagnetic signals based on the phase relationships of the restructured signals. The in-phase restructured signals create a first radiation pattern corresponding to common-mode operation, while the anti-phase restructured signals create a second radiation pattern corresponding to differential-mode operation. These different radiation patterns enable the generation of uncorrelated MIMO signals from the single antenna structure.

The rat-race coupler 205 can be implemented using various transmission line technologies. For example, in microstrip implementations, the transmission line segments can have conductive traces on a dielectric substrate. In stripline implementations, the transmission line segments can be embedded within dielectric layers. The characteristic impedance of the transmission line segments can be designed to match the system impedance, commonly 50Ω, to minimize reflections and maximize power transfer efficiency.

The physical dimensions of the rat-race coupler 205 depend on the operating frequency and the dielectric properties of the substrate material. For a given frequency, the quarter-wavelength segments have a physical length determined by the wavelength in the transmission line medium, which is shorter than the free-space wavelength due to the dielectric loading effect of the substrate material. The rat-race coupler 205 can be fabricated using standard printed circuit board manufacturing processes or integrated circuit fabrication techniques, depending on the frequency range and integration requirements of the specific application.

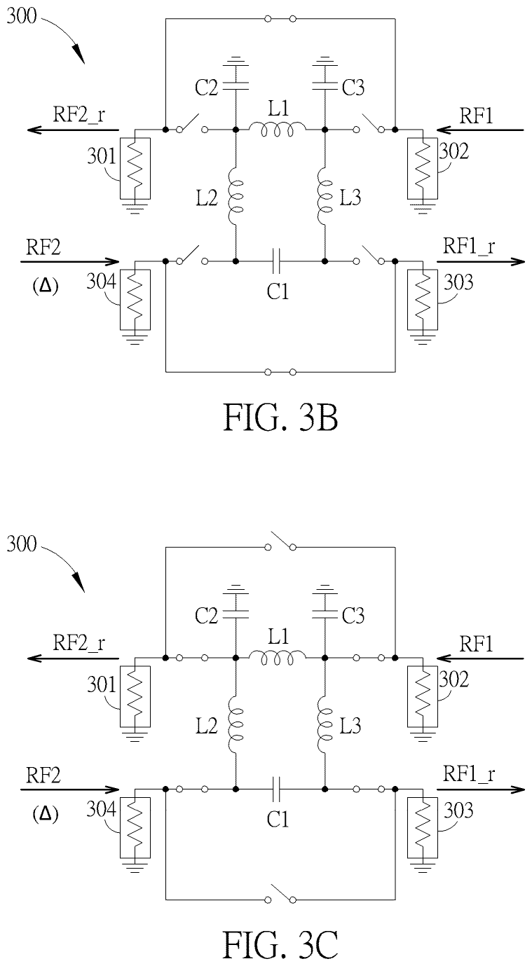

FIG. 3A depicts a signal restructure unit 300 according to an alternative embodiment of the present invention. The signal restructure unit 300 represents an implementation of the signal restructure unit illustrated in FIGS. 1A and 1B. In addition, the signal restructure unit 300 includes discrete circuit elements that provide physical or functional equivalents to the distributed transmission line structure shown in FIG. 2.

The signal restructure unit 300 includes four ports: a first port 301, a second port 302, a third port 303, and a fourth port 304. Each port is coupled to a characteristic impedance element Z0 that provides impedance matching to external circuitry. The second port 302 receives RF signal RF1 having a sum signal (Σ), while the fourth port 304 receives RF signal RF2 having a difference signal (Δ). The first port 301 provides restructured signal RF2_r, and the third port 303 provides restructured signal RF1_r to external circuits or antenna elements.

The circuit topology includes three inductive elements and three capacitive elements arranged to create the required phase relationships. A first inductive element L1 is coupled between the second port 302 and the first port 301. A second inductive element L2 is coupled between the fourth port 304 and the first port 301. A third inductive element L3 is coupled between the second port 302 and the third port 303. The inductive elements L1, L2, and L3 have substantially equal inductance values to maintain circuit symmetry.

The capacitive elements provide AC coupling and phase adjustment functions within the circuit. A first capacitive element C1 is coupled between the fourth port 304 and the third port 303. A second capacitive element C2 is coupled between a node connecting L1 and L2 to ground. A third capacitive element C3 is coupled between a node connecting L1 and L3 to ground. The second capacitive element C2 and third capacitive element C3 each have a capacitance value approximately twice that of the first capacitive element C1.

The impedance elements Z0 at each port provide characteristic impedance matching, typically 50Ω, to provide proper signal transfer and minimize reflections. Each impedance element Z0 can be coupled between its respective port and ground, establishing the reference impedance for the circuit operation.

The signal restructure unit 300 can operate by utilizing the reactive properties of the inductive and capacitive elements to create controlled phase relationships between the input and output signals. When RF signal RF1 having a sum signal (Σ) is applied to the second port 302, the circuit provides restructured signals RF2_r and RF1_r at the first port 301 and third port 303 respectively with a 0° phase relationship. The inductive and capacitive elements create equal phase delays to both output ports through their reactive impedance characteristics.

When RF signal RF2 having a difference signal (Δ) is applied to the fourth port 304, the circuit provides restructured signals RF2_r and RF1_r at the first port 301 and third port 303 respectively with a 180° phase relationship. The asymmetric coupling paths through the reactive elements create the 180° phase difference between the restructured output signals.

The lumped element implementation offers several advantages for integrated circuit applications. The discrete components can be fabricated using standard semiconductor processes, including CMOS technology. Inductive elements can be implemented as spiral inductors, bondwire inductors, or active inductor circuits. Capacitive elements can be implemented as metal-insulator-metal (MIM) capacitors, metal-oxide-metal (MOM) capacitors, or junction capacitors depending on the specific process technology and performance requirements.

The component values can be scaled according to the operating frequency, with higher frequencies requiring smaller inductance and capacitance values. The circuit can be designed and optimized using standard RF circuit simulation tools to achieve the desired phase relationships and impedance matching across the intended frequency band of operation.

FIG. 3B depicts the signal restructure unit 300 operating in bypass mode according to an embodiment of the present invention. In this configuration, the signal restructure unit 300 includes switching elements that allow direct signal routing without phase restructuring, providing operational flexibility for different system requirements.

The signal restructure unit 300 includes the same basic circuit topology as shown in FIG. 3A, including the first port 301, second port 302, third port 303, fourth port 304, the inductive elements L1, L2 and L3, and the capacitive elements C1, C2, and C3. Each port remains coupled to its respective characteristic impedance element Z0 for proper impedance matching. The bypass mode configuration includes additional switching elements that modify the signal routing paths.

The bypass mode operation can be controlled by two sets of switching elements positioned within the circuit. A first set of switching elements is positioned to isolate the reactive circuit elements from the signal paths when activated. A second set of switching elements is positioned to create direct signal routing paths between input and output ports when activated.

In the bypass mode configuration shown in FIG. 3B, the first set of switching elements is in an isolating state, effectively disconnecting the reactive circuit elements L1, L2, L3, C1, C2, and C3 from the active signal paths. This isolation can prevent the reactive elements from influencing the phase relationships of the signals passing through the signal restructure unit 300.

Simultaneously, the second set of switching elements is in a conductive state, establishing direct conductive paths between the input ports and output ports. These direct paths allow RF signals to pass through the signal restructure unit 300 without undergoing phase restructuring. The switching elements in the conductive state provide low-impedance paths that maintain signal integrity while bypassing the reactive circuit elements.

When operating in bypass mode, RF signal RF1 applied to the second port 302 passes directly to the first port 301 without phase modification. Similarly, RF signal RF2 applied to the fourth port 304 passes directly to the third port 303 without phase modification. The bypass operation maintains the original phase relationships of the input signals, effectively disabling the restructuring function of the unit.

During system initialization or calibration procedures, the bypass mode allows direct signal measurements without the influence of the restructuring circuit. For compatibility with conventional antenna systems, the bypass mode enables operation with traditional single-input antenna configurations. Additionally, the bypass mode can serve as a diagnostic tool for troubleshooting system performance by isolating the effects of the restructuring circuit.

The switching elements can be implemented using various semiconductor technologies. In CMOS implementations, the switches may include MOSFET transistors configured as transmission gates or series switches. In GaAs or other compound semiconductor technologies, the switches may include FET devices optimized for RF performance. The switching control can be provided by digital control signals from external control circuitry, allowing dynamic reconfiguration of the signal restructure unit operation.

The impedance characteristics of the switching elements can be designed to minimize signal distortion in both the isolating and conductive states. In the conductive state, the switches present low on-resistance to minimize insertion loss. In the isolating state, the switches present high off-impedance to provide adequate isolation. The switching elements are typically designed to handle the RF power levels and frequency ranges required by the specific application.

FIG. 3C depicts the signal restructure unit 300 operating in active mode according to an embodiment of the present invention. In this configuration, the signal restructure unit 300 enables full signal restructuring functionality through the controlled activation of switching elements that connect the reactive circuit elements to the signal paths.

The signal restructure unit 300 maintains the same basic circuit topology as shown in FIG. 3A and FIG. 3B, including the first port 301, second port 302, third port 303, fourth port 304, the inductive elements L1, L2 and L3, and the capacitive elements C1, C2, and C3. Each port remains coupled to its respective characteristic impedance element Zₒ for proper impedance matching. The active mode configuration utilizes the switching elements to enable the signal restructuring functionality.

In the active mode configuration shown in FIG. 3C, the first set of switching elements is in a conductive state, establishing conductive paths that connect the reactive circuit elements L1, L2, L3, C1, C2, and C3 to the active signal paths. The connection provides the reactive elements to influence the phase relationships of the signals passing through the signal restructure unit 300, enabling the desired signal restructuring operation.

Simultaneously, the second set of switching elements is in an isolating state, disconnecting the direct bypass paths between the input and output ports. This isolation forces the RF signals to travel through the reactive circuit elements rather than bypassing them, ensuring that the signals undergo the intended phase transformations.

When operating in active mode, the signal restructure unit 300 performs its primary signal restructuring function. RF signal RF1 having a sum signal applied to the second port 302 undergoes phase processing through the reactive circuit elements and emerges as restructured signals RF2_r and RF1_r at the first port 301 and third port 303 respectively with a 0° phase relationship. The inductive elements L1, L2, and L3, working in conjunction with the capacitive elements C1, C2, and C3, yielding the controlled phase delays necessary to achieve the in-phase output condition.

Similarly, RF signal RF2 having a difference signal applied to the fourth port 304 undergoes phase processing through the reactive circuit elements and emerges as restructured signals RF2_r and RF1_r at the first port 301 and third port 303 respectively with a 180° phase relationship. The asymmetric coupling paths created by the reactive elements generate the 180° phase difference between the restructured output signals, enabling differential-mode operation.

The switching elements that control the active mode operation can be designed to handle the RF signal characteristics while maintaining low insertion loss and high isolation. In the conductive state, the switches provide low-impedance connections that minimize signal attenuation through the reactive elements.

The transition between bypass mode and active mode can be controlled through external control signals. This reconfigurable capability allows the RF system to adapt to different operating conditions or antenna configurations. For example, the RF system might operate in bypass mode or switch to active mode for different MIMO channels operations. The control of the switching elements can be integrated with the overall RF system control architecture, allowing coordination between the signal restructure unit operation and other system functions such as power control, channel estimation, and adaptive antenna algorithms.

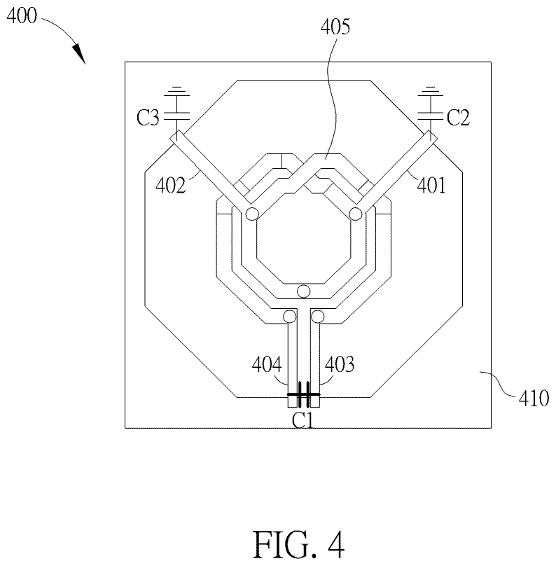

FIG. 4 depicts a signal restructure unit 400 according to an embodiment of the present invention. The signal restructure unit 400 is implemented using fully-depleted silicon-on-insulator (FD-SOI) CMOS technology, which demonstrates an integrated circuit implementation of the lumped element circuit topology described in previous figures.

The signal restructure unit 400 can be fabricated on a substrate 410 using FD-SOI CMOS process technology, which provides enhanced RF performance characteristics. The FD-SOI technology enables reduced parasitic capacitances, improved isolation between circuit elements, and better control of threshold voltages, making it particularly suitable for RF and millimeter wave applications.

The integrated circuit layout includes four ports positioned around the periphery of the substrate 410, including a first port 401, a second port 402, a third port 403, and a fourth port 404. The first port 401 and second port 402 are positioned on the upper portion of the substrate 410, while the third port 403 and fourth port 404 are positioned on the lower portion of the substrate 410.

The circuit topology can be implemented using metal interconnect layers and integrated passive components formed within the FD-SOI CMOS process. Capacitive elements C1, C2, and C3 can be integrated into the structure using metal-insulator-metal (MIM) capacitor configurations or metal-oxide-metal (MOM) capacitor structures. The capacitive element C1 is positioned at the bottom center of the layout, providing coupling between the lower ports. The capacitive elements C2 and C3 are positioned at the upper left and upper right portions of the layout respectively, providing ground coupling for the upper signal paths. The inductive elements can be implemented using spiral inductor structures formed from the metal interconnect layers. The inductor layouts can be optimized to minimize parasitic effects and maximize quality factor (Q) at the operating frequency.

The metal interconnect lines 405 forming the signal routing paths are implemented using the upper metal layers of the FD-SOI CMOS process. The metal interconnect lines 405 provide low-resistance connections between the circuit elements and ports. The trace widths and spacing are optimized for the characteristic impedance requirements and are optimized for the electromagnetic coupling between adjacent signal paths.

Overlapping regions can be positioned throughout the layout where portions of the metal interconnect lines 405 are disposed in different metal layers. These overlapping regions provide controlled capacitive coupling between signal paths, implementing portions of the required capacitive elements through inter-layer capacitance. The overlapping regions enable fine-tuning of the circuit response and provide additional design flexibility for optimizing the phase relationships.

The FD-SOI CMOS implementation provides several advantages for RF applications. The thin silicon layer and buried oxide layer in FD-SOI technology reduce substrate losses and improve isolation between circuit elements. The reduced parasitic capacitances enable higher frequency operation while maintaining circuit performance. The process also provides better control over device characteristics, enabling more predictable circuit behavior and improved manufacturing yield.

The integrated circuit layout can be designed to operate with standard 50Ω system impedances while providing the phase relationships required for MIMO antenna applications. The compact layout enables integration with other RF circuit functions on the same substrate 410, reducing overall system size and cost. The layout dimensions are typically on the order of several hundred micrometers, making it suitable for integration in modern RF communication systems.

The ports 401, 402, 403, and 404 include impedance matching structures to ensure proper signal transfer to external circuits. These matching structures may include additional passive components or optimized trace geometries designed to minimize reflections and maximize power transfer efficiency. The port structures are designed to handle the RF power levels and frequency ranges required by the specific application.

The FD-SOI CMOS implementation enables mass production using standard semiconductor manufacturing processes, providing cost-effective solutions for high-volume applications. The process compatibility with digital CMOS circuits also enables integration of control circuitry and digital signal processing functions on the same substrate, creating highly integrated RF communication solutions.

Additionally, the layout includes consideration for electromagnetic compatibility and thermal management. Ground planes and shielding structures may be incorporated to minimize electromagnetic interference between circuit sections. Thermal vias and heat spreading structures can be included to manage power dissipation and maintain stable operating temperatures across varying environmental conditions.

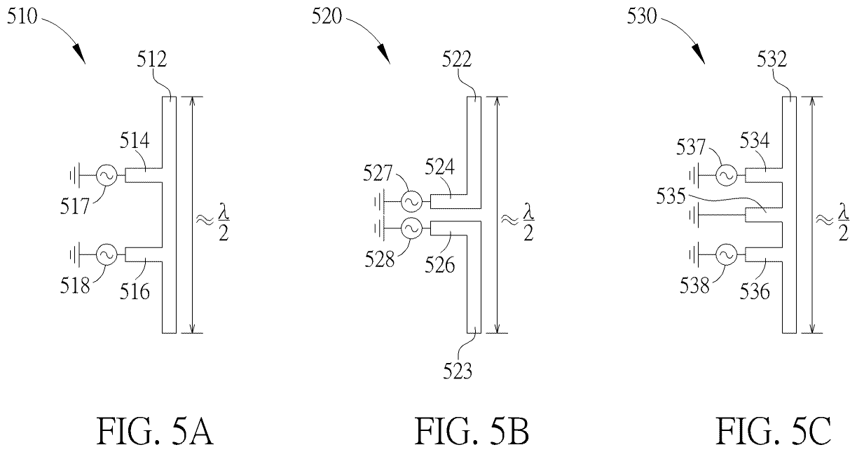

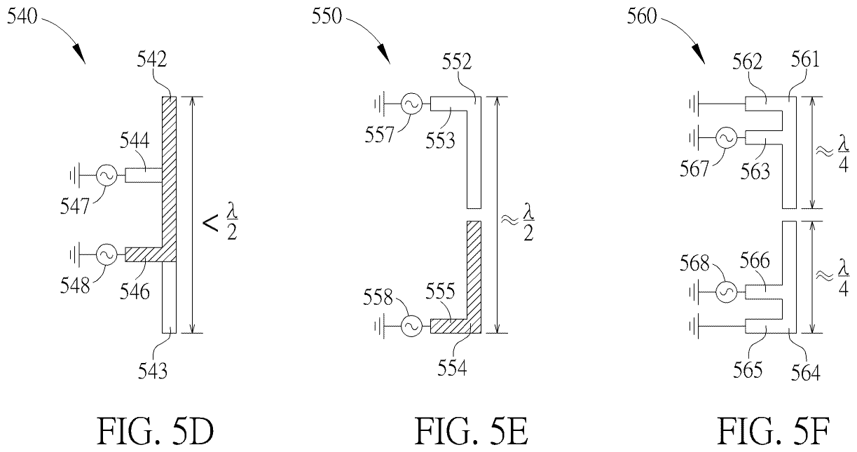

FIGS. 5A-5F depict various antenna configurations that can be utilized with the signal restructure unit according to different embodiments of the present invention. These antenna designs demonstrate alternative implementations for achieving MIMO operation through signal restructuring, where each configuration may provide specific performance characteristics suitable for different applications.

FIG. 5A depicts antenna 510 having a dual horizontal element configuration that provides MIMO operation through spatially separated feed points along a common vertical structure. The antenna 510 includes a vertical radiating element 512 having a length of approximately λ/2. The vertical radiating element 512 may be implemented as a wire antenna, microstrip antenna in a substrate, or a metal-frame antenna in the mobile phone structure depending on the grounding configuration and application requirements.

A first horizontal feeding element 514 is disposed at a first location along the vertical radiating element 512. The first horizontal feeding element 514 may extend perpendicular to the vertical radiating element 512 and can have a length optimized for the operating frequency. The first horizontal feeding element 514 includes a first feed point 517 where RF signals can be applied or extracted. The first feed point 517 may be positioned at an optimal location along the first horizontal feeding element 514 to achieve desired impedance matching and radiation characteristics.

A second horizontal feeding element 516 is disposed at a second location along the vertical radiating element 512, spaced apart from the first horizontal feeding element 514. The second horizontal feeding element 516 may be substantially parallel to the first horizontal feeding element 514 and can have similar dimensional characteristics. The second horizontal feeding element 516 includes a second feed point 518 where RF signals can be applied or extracted independently from the first feed point 517.

The signal restructure unit may be connected such that its first port couples to the first feed point 517 and its third port couples to the second feed point 518. This configuration enables the antenna 510 to operate in different modes based on the phase relationships provided by the signal restructure unit. The vertical spacing between the horizontal elements may be optimized to achieve desired isolation and radiation pattern characteristics.

FIG. 5B depicts antenna 520 having two L-shaped radiating structures arranged in a symmetric configuration to form a compact MIMO antenna system. A first L-shaped radiating structure includes a first arm 522 extending in a vertical direction and a second arm 524 extending in a horizontal direction perpendicular to the vertical direction. The first arm 522 and second arm 524 may be connected at their junction to form the L-shaped geometry. The second arm 524 includes a first feed point 527 where RF signals can be applied or extracted. The first feed point 527 may be positioned at an optimal location along the second arm 524 to achieve desired input impedance characteristics.

A second L-shaped radiating structure includes a first arm 523 extending in a vertical direction opposite to that of the first arm 522 of the first L-shaped radiating structure. The second L-shaped radiating structure further includes a second arm 526 that extends in a horizontal direction parallel to the second arm 524 of the first L-shaped radiating structure. The second L-shaped radiating structure includes a second feed point 528 disposed at the second arm 526.

The total length of the first arms 522 and 523 of both L-shaped radiating structures may be approximately λ/2, providing resonant operation at the desired frequency. The first and second L-shaped radiating structures can form a symmetrical structure centered about the second arms, creating balanced electromagnetic characteristics. This symmetric arrangement may provide improved isolation between the feed points and enhanced MIMO performance.

FIG. 5C depicts antenna 530 having an enhanced multi-element configuration that extends the dual-element concept by incorporating an additional horizontal feeding element for enhanced performance characteristics. The antenna 530 includes a vertical radiating element 532 having a length of approximately λ/2. A first horizontal feeding element 534 is disposed at a first location along the vertical radiating element 532 and includes a first feed point 537. A second horizontal feeding element 536 is disposed at a second location along the vertical radiating element 532 and includes a second feed point 538. These elements may function similarly to those described in FIG. 5A.

Additionally, a third horizontal feeding element 535 is disposed at a third location along the vertical radiating element 532, positioned between the first location and the second location. The third horizontal feeding element 535 includes a third feed point that can be coupled to ground or other reference potential. The third horizontal feeding element 535 may serve as a parasitic element or provide additional control over the antenna's radiation characteristics and impedance matching. The inclusion of the third horizontal feeding element 535 may provide enhanced bandwidth, improved radiation pattern control, or better isolation between the active feed points. The third feed point being coupled to ground can create a reference point that influences the current distribution along the vertical radiating element 532, thereby affecting the overall antenna performance.

FIG. 5D depicts antenna 540 having a multi-layer L-shaped antenna configuration that provides compact MIMO operation through vertical stacking of radiating elements. This configuration may enable reduced footprint while maintaining effective antenna performance.

The antenna 540 includes a first L-shaped radiating structure disposed at a first layer. The first L-shaped radiating structure includes a first arm 543 extending in a vertical direction and a second arm 544 extending in a horizontal direction perpendicular to the vertical direction. The first L-shaped radiating structure includes a first feed point 547 disposed at the second arm, where RF signals can be applied or extracted.

A second L-shaped radiating structure is disposed at a second layer above the first layer. The second L-shaped radiating structure includes a first arm 542 extending in a vertical direction opposite to the first arm 543 of the first L-shaped radiating structure. The first arm 542 of the second L-shaped radiating structure may partially overlap the first arm 543 of the first L-shaped radiating structure, creating controlled electromagnetic coupling between the layers.

The second L-shaped radiating structure further includes a second arm 546 extending in a horizontal direction parallel to the second arm 544 of the first L-shaped radiating structure. A second feed point 548 is disposed at the second arm 546 of the second L-shaped radiating structure, providing an independent signal connection point.

The total length of the first arms 542 and 543 of both L-shaped radiating structures may be less than λ/2 due to the overlapping configuration. The first and second L-shaped radiating structures form a symmetrical structure such that the second arms are positioned at opposing ends of the symmetrical structure, providing balanced electromagnetic characteristics.

FIG. 5E depicts antenna 550 having L-shaped radiating structures arranged in a symmetrical configuration that provides compact MIMO operation through opposing L-shaped elements. This configuration may provide enhanced performance characteristics and improved structural symmetry.

The antenna 550 includes a first L-shaped radiating structure having a first arm 552 extending in a vertical direction and a second arm 553 connected to the first arm 552 and extending in a horizontal direction. The first L-shaped radiating structure includes a first feed point 557 disposed at the second arm 553, where RF signals can be applied or extracted.

A second L-shaped radiating structure includes a first arm 554 extending in a vertical direction opposite to the first arm 552 of the first L-shaped radiating structure. The second L-shaped radiating structure further includes a second arm 555 connected to the first arm 554 of the second L-shaped radiating structure and extending parallel to the second arm 553 of the first L-shaped radiating structure. The second L-shaped radiating structure includes a second feed point 558 disposed at the second arm 555 of the second L-shaped radiating structure, providing an independent signal connection point.

The total length of the first arms 552 and 554 of the first L-shaped radiating structure and the second L-shaped radiating structure may be approximately greater than λ/2. The first and second L-shaped radiating structures form a symmetrical structure such that the second arms 553 and 555 are positioned at opposing ends of the symmetrical structure, providing balanced electromagnetic characteristics and improved isolation between the feed points.

FIG. 5F depicts antenna 560 having F-shaped radiating structures that provide enhanced radiating characteristics through additional horizontal elements compared to L-shaped configurations. This design may offer improved bandwidth and radiation efficiency.

The antenna 560 includes a first F-shaped radiating structure having a first arm 561 extending in a vertical direction. A second arm 562 is connected to the first arm 561 and extends in a horizontal direction. A third arm 563 is also connected to the first arm 561 and extends parallel to the second arm 562, creating the characteristic F-shaped geometry.

The first F-shaped radiating structure includes a first feed point 567 disposed at the third arm 563. The positioning of the feed point 567 at the third arm 563 may provide specific impedance characteristics and radiation pattern control compared to feeding at the second arm 562.

A second F-shaped radiating structure includes a first arm 564 extending in a vertical direction opposite to the first arm 561 of the first F-shaped radiating structure. The second F-shaped radiating structure includes a second arm 565 connected to the first arm 564 and extending in a horizontal direction. A third arm 566 is connected to the first arm 564 and extends parallel to the second arm of the second F-shaped radiating structure.

A second feed point 568 is disposed at the third arm 566 of the second F-shaped radiating structure, providing an independent signal connection point. The length of the first arms 561 and 564 of both F-shaped radiating structures may each be approximately λ/4, enabling effective radiation at the operating frequency while maintaining compact dimensions. The first arms 561 and 564 of both F-shaped radiating structures may have a small gap under λ/8, λ/10, λ/15, or λ/20. The total length of the first arms 561 and 564 of both F-shaped radiating structures may be approximately greater than λ/2.

The first and second F-shaped radiating structures form a symmetrical structure such that the third arms are positioned at opposing ends of the symmetrical structure. This symmetric arrangement may provide balanced electromagnetic characteristics and improved isolation between the feed points compared to asymmetric configurations.

These antenna configurations may be optimized for specific frequency bands and application requirements. The dimensional parameters, including the lengths of radiating elements and spacing between feed points, can be adjusted to achieve desired performance metrics such as return loss, isolation, gain, and radiation pattern characteristics.

The antenna structures may be fabricated using various techniques including printed circuit board (PCB) technology, flexible substrates, metal-frame or housing in the mobile phone, or three-dimensional manufacturing methods. The choice of fabrication method may depend on the specific application requirements, frequency of operation, and integration constraints.

These antenna configurations demonstrate the versatility of the signal restructure unit concept, showing how different antenna topologies can benefit from signal restructuring to achieve MIMO operation from compact, single-antenna structures. Each configuration may offer specific advantages in terms of size, performance, or manufacturing considerations, allowing system designers to select the most appropriate implementation for their particular application.

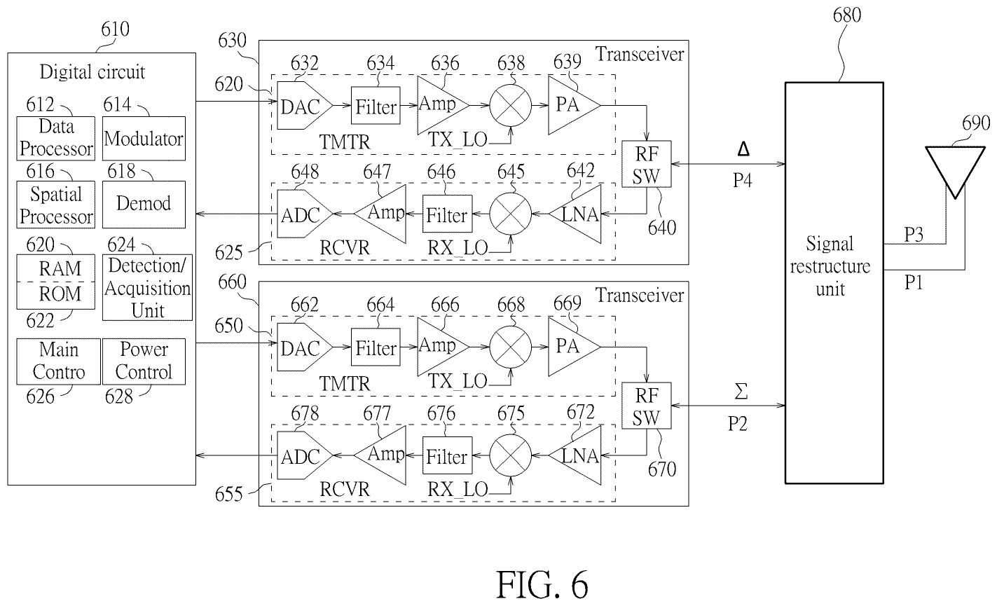

FIG. 6 depicts an RF communication system 600 according to an embodiment of the present invention, showing a complete MIMO communication system that integrates digital processing, transceivers, and a signal restructure unit with antenna for enhanced performance. The RF communication system 600 demonstrates the signal restructure unit being implemented within a comprehensive communication architecture. The RF communication system 600 includes a digital circuit 610, transceivers 630 and 660, a signal restructure unit 680 and an antenna 690.

The digital circuit 610 (e.g., a modem) can generate and process digital baseband signals. The digital circuit 610 includes several functional blocks that work together to handle digital signal processing operations. The digital circuit 610 includes a data processor 612, a modulator 614, a spatial processor 616, a demodulator 618, a detection and acquisition unit 624, a main control unit 626, a power control unit 628, and memory units including random access memory (RAM) 620 and read-only memory (ROM) 622.

The data processor 612 processes digital data that may be received from external sources or generated internally. The data processor 612 handles various data formatting, encoding, and protocol processing functions necessary for communication operations. The modulator 614 is coupled to the data processor 612 and modulates the digital data into digital baseband signals suitable for transmission. The modulator 614 may implement various modulation schemes such as QPSK, QAM, or other appropriate modulation techniques depending on the communication standard and requirements. The spatial processor 616 processes spatial diversity signals for MIMO operation. The spatial processor 616 may implement algorithms for spatial coding, beamforming, or other MIMO signal processing techniques that enable the generation of uncorrelated signals for transmission through the signal restructure unit. The demodulator 618 is coupled to the spatial processor 616 and demodulates received digital baseband signals into digital data. The demodulator 618 performs the inverse operations of the modulator 614, recovering the transmitted data from the received signals.

The detection and acquisition unit 624 detects and acquires incoming signals. It may handle functions such as signal detection, timing recovery, frequency offset estimation, and channel estimation necessary for proper signal reception. The main control unit 626 coordinates operation of the data processor 612, modulator 614, spatial processor 616, and demodulator 618. The main control unit 626 provides overall system control and coordination between the various functional blocks. The power control unit 628 controls transmission power levels of the system. The power control unit 628 may adjust transmit power based on channel conditions, regulatory requirements, or system optimization algorithms.

The memory units including RAM 620 and ROM 622 provide storage for program instructions, configuration data, and temporary data storage during system operation. The main control unit 626 may execute control algorithms stored in the memory units to coordinate system operation.

The first transceiver 630 is coupled to the digital circuit 610. The first transceiver 630 converts digital baseband signals to first RF signals and converts received first RF signals to digital baseband signals. The first transceiver 630 includes a transmitter unit (TMTR) 620 and a receiver unit (RCVR) 625.

The transmitter unit 620 includes a digital-to-analog converter (DAC) 632, a filter 634, an amplifier 636, a mixer 638, a power amplifier (PA) 639, and an RF switch 640. The transmitter unit 620 converts digital baseband signals to RF signals for transmission.

The DAC 632 converts the digital baseband signals to analog baseband signals. The filter 634 is coupled to the DAC 632 and filters the analog baseband signals to remove unwanted frequency components and provide spectral shaping. The amplifier 636 is coupled to the filter 634 and amplifies the filtered analog baseband signals to appropriate levels for further processing. The mixer 638 is coupled to the amplifier 636 and converts the amplified baseband signals to RF frequency using a transmit local oscillator signal TX_LO. The mixer 638 performs frequency up-conversion to translate the baseband signals to the desired RF transmission frequency. The power amplifier (PA) 639 is coupled to the mixer 638 and amplifies the converted signals to generate the first RF signals at the required power levels for transmission. The RF switch 640 is coupled between the power amplifier 639 and the signal restructure unit 680, providing control over signal routing and isolation when needed.

The receiver unit 625 includes a low noise amplifier (LNA) 642, a mixer 645, a filter 646, an amplifier 647, and an analog-to-digital converter (ADC) 648. The receiver unit RCVR 625 converts received RF signals to digital baseband signals. The LNA 642 amplifies received incoming RF signals while adding minimal noise to preserve signal quality. The mixer 645 is coupled to the LNA 642 and converts the amplified RF signals to baseband frequency using a receive local oscillator signal RX_LO. The filter 646 is coupled to the mixer 645 and filters the converted signals to remove unwanted frequency components and provide channel selectivity. The amplifier 647 is coupled to the filter 646 and amplifies the filtered signals to appropriate levels for analog-to-digital conversion. The ADC 648 is coupled to the amplifier 647 and converts the amplified analog signals to digital baseband signals for processing by the digital circuit 610.

The second transceiver 660 is also coupled to the digital circuit 610. The second transceiver 660 has a similar architecture to the first transceiver 630 and converts digital baseband signals to second RF signals and converts received second RF signals to digital baseband signals. The second transceiver 660 includes a transmitter unit 650 and a receiver unit 655.

The transmitter unit 650 includes a DAC 662, a filter 664, an amplifier 666, a mixer 668, a power amplifier 669, and an RF switch 670. These components perform similar functions to their counterparts in the first transceiver 630, processing the second channel of digital baseband signals for transmission.

The receiver unit 655 includes an LNA 672, a mixer 675, a filter 676, an amplifier 677, and an ADC 678. These components process received RF signals for the second channel, converting them to digital baseband signals for processing by the digital circuit 610.

The signal restructure unit 680 is coupled to both the first transceiver 630 and the second transceiver 660. The signal restructure unit 680 includes ports P1, P2, P3, and P4 that interface with the transceivers and antenna. The signal restructure unit 680 receives first RF signals from the first transceiver 630 and second RF signals from the second transceiver 660, and outputs restructured RF signals with controlled phase relationships.

Port P4 receives RF signals having a difference signal (Δ) from the first transceiver 630. Port P2 receives RF signals having a sum signal (Σ) from the second transceiver 660. Ports P1 and P3 provide restructured output signals to the antenna 690.

The signal restructure unit 680 provides in-phase restructured signals to ports P1 and P3 when receiving sum signals (Σ) at port P2, providing common-mode operation of the antenna 690. Conversely, the signal restructure unit 680 provides anti-phase restructured signals to ports P1 and P3 when receiving difference signals (Δ) at port P4, providing differential-mode operation of the antenna 690.

The MIMO antenna 690 is coupled to the signal restructure unit 680 through ports P1 and P3. The antenna 690 radiates the restructured RF signals and receives incoming RF signals. The antenna 690 operates in different modes based on the phase relationships of the restructured signals provided by the signal restructure unit 680.

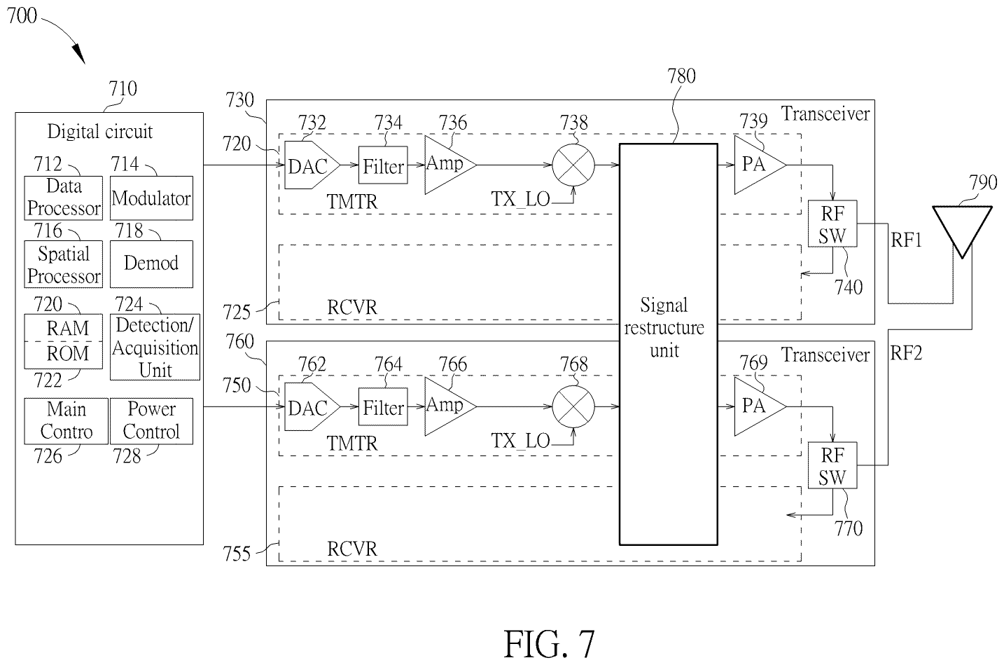

FIG. 7 depicts an RF communication system 700 according to another embodiment of the present invention. This embodiment shows an alternative configuration where the signal restructure unit 780 positioned at a different location than the RF communication system of FIG. 6, demonstrating the flexibility of the signal restructure unit placement within the RF signal chain. The RF communication system 700 includes a digital circuit 710, transceivers 730 and 760, a signal restructure unit 780, and an antenna 790.

The digital circuit 710 handles digital signal processing operations for the communication system. The digital circuit 710 includes a data processor 712, a modulator 714, a spatial processor 716, a demodulator 718, a detection and acquisition unit 724, a main control unit 726, a power control unit 728, and memory units including RAM 720 and ROM 722.

The data processor 712 processes digital data that may be received from external sources or generated internally. The modulator 714 is coupled to the data processor 712 and modulates the digital data into digital baseband signals suitable for transmission. The spatial processor 716 processes spatial diversity signals for MIMO operation, implementing algorithms for spatial coding, beamforming, or other MIMO signal processing techniques.

The demodulator 718 is coupled to the spatial processor 716 and demodulates received digital baseband signals into digital data. The detection and acquisition unit 724 detects and acquires incoming signals, handling functions such as signal detection, timing recovery, and channel estimation. The main control unit 726 coordinates operation of the various processing components, while the power control unit 728 controls transmission power levels.

The memory units including RAM 720 and ROM 722 provide storage for program instructions, configuration data, and temporary data during system operation. The main control unit 726 may execute control algorithms stored in the memory units to coordinate overall system operation.

The first transceiver 730 is coupled to the digital circuit 710 and includes transmit and receive signal processing components. The transmit path includes a digital-to-analog converter (DAC) 732, a filter 734, an amplifier 736, and a mixer 738. The receive path includes corresponding components for processing received RF signals.

The DAC 732 converts digital baseband signals from the digital circuit 710 to analog baseband signals. The filter 734 is coupled to the DAC 732 and filters the analog baseband signals to remove unwanted frequency components and provide spectral shaping. The amplifier 736 is coupled to the filter 734 and amplifies the filtered analog baseband signals to appropriate levels for frequency conversion.

The mixer 738 is coupled to the amplifier 736 and converts the amplified baseband signals to RF frequency using a transmit local oscillator signal TX_LO. The mixer 738 performs frequency up-conversion to translate the baseband signals to the desired RF transmission frequency. The output of the mixer 738 is provided to the signal restructure unit 780.

The second transceiver 760 is coupled to the digital circuit 710 and has a similar architecture to the first transceiver 730. The transmit path includes a DAC 762, a filter 764, an amplifier 766, and a mixer 768. The receive path includes corresponding receive components.

The components of the second transceiver 760 perform similar functions to their counterparts in the first transceiver 730. The DAC 762 converts digital baseband signals to analog baseband signals, the filter 764 provides spectral shaping, the amplifier 766 amplifies the filtered signals, and the mixer 768 performs frequency up-conversion using a transmit local oscillator signal TX_LO. The output of the mixer 768 is also provided to the signal restructure unit 780 for signal processing.

The signal restructure unit 780 can be positioned at different locations within the transmit and receive signal paths. On the transmit side, the signal restructure unit 780 can be positioned between the mixers and power amplifiers of the transceivers. On the receive side, a signal restructure unit can be positioned between the low noise amplifiers (LNA) and mixers of the transceivers. The signal restructure unit coupled to the receivers can be different signal restructure units, depending on the specific system implementation and requirements.

For transmitting operation, the signal restructure unit 780 receives RF signals from the mixers 738 and 768 of the first and second transceivers respectively, and provides phase-controlled signals to downstream power amplifiers. The signal restructure unit 780 processes these signals to generate restructured RF signals with controlled phase relationships.

For receiving operation, the signal restructure unit processes RF signals from the antenna 790 that have been initially amplified by the low noise amplifiers in each transceiver. The signal restructure unit processes these received signals to maintain the appropriate phase relationships before providing them to the mixers for frequency down-conversion.

Similarly, the signal restructure unit 780 provides in-phase restructured signals when processing sum signals, enabling common-mode operation, and provides anti-phase restructured signals when processing difference signals, enabling differential-mode operation.

Following the signal restructure unit 780, the signal path includes power amplifiers PA 739 and PA 769 that amplify the restructured signals from the signal restructure unit 780 to the required power levels for transmission. RF switches 740 and 770 are positioned after the power amplifiers to provide control over signal routing and isolation when needed.

The power amplifier PA 739 amplifies the restructured signals for the first transmission path, while the power amplifier PA 769 amplifies the restructured signals for the second transmission path. The RF switches 740 and 770 provide switching control for the respective signal paths, enabling transmit/receive switching and system control functions.

The MIMO antenna 790 is coupled to the output of the RF switches and receives the amplified restructured RF signals for radiation. The antenna 790 operates in different modes based on the phase relationships of the restructured signals provided by the signal restructure unit 780 for generating uncorrelated MIMO signals from the single antenna structure.

The positioning of the signal restructure unit 780 at different locations within the transmit and receive signal paths provides several potential advantages. On the transmit side, positioning between the mixers and power amplifiers allows signal restructuring to occur at intermediate power levels, which may reduce power handling requirements for the signal restructure unit components. On the receive side, positioning between the low noise amplifiers and mixers enables signal restructuring to occur after initial low-noise amplification but before frequency down-conversion.

The transmit path placement may provide the power amplifiers to operate on the restructured signals, potentially providing better overall system efficiency. The receive path placement allows the signal restructure unit to process RF signals that have been amplified by the LNAs while maintaining low noise characteristics, providing that the phase relationships are properly maintained throughout the receive signal chain.

The alternative positioning demonstrates the flexibility of the signal restructure unit concept, showing that signal restructuring can be implemented at multiple points within both transmit and receive RF signal chains depending on specific system requirements and optimization goals. This configuration may provide improved isolation between the signal paths and enables better control over signal phase relationships at appropriate signal levels in both directions.

The RF communication system 700 operates similarly to other embodiments, with the primary difference being the positioning of the signal restructure unit 780 within the signal chain. During transmission, digital baseband signals are processed by the digital circuit 710 and converted to RF signals by the transceivers up to the mixer stage. The signal restructure unit 780 then processes these signals to create the appropriate phase relationships before final amplification and transmission through the antenna 790.

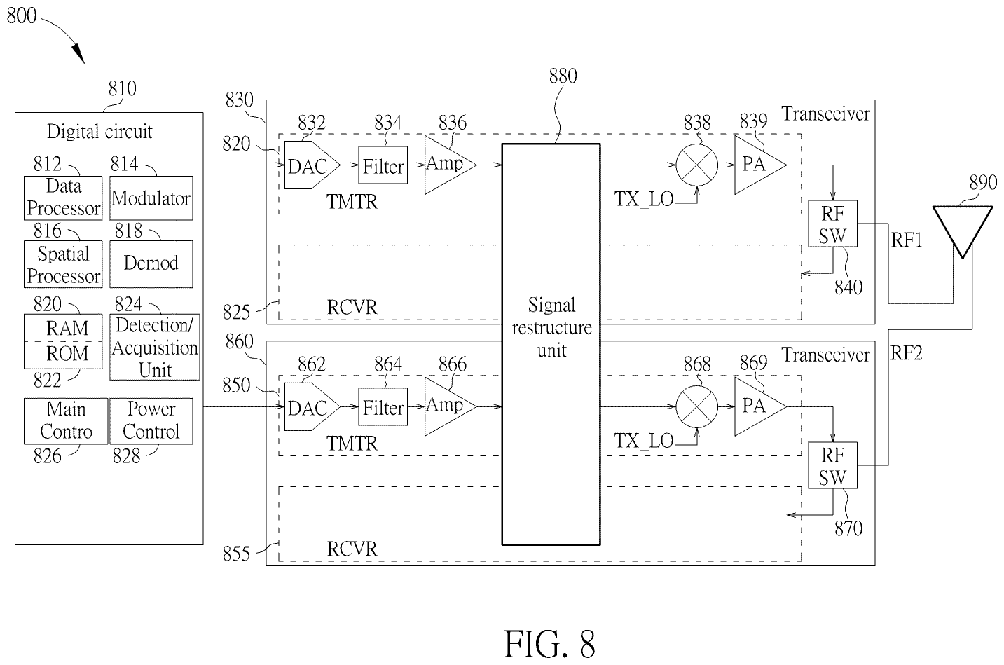

FIG. 8 depicts an RF communication system 800 according to another embodiment of the present invention. This embodiment shows an alternative configuration where the signal restructure unit 880 positioned at the baseband portion of the signal chain, demonstrating the flexibility of signal reconstructing at baseband level. The RF communication system 800 includes a digital circuit 810, transceivers 830 and 860, a signal restructure unit 880, and an antenna 890.

The digital circuit 810 handles digital signal processing operations for the communication system. The digital circuit 810 includes a data processor 812, a modulator 814, a spatial processor 816, a demodulator 818, a detection and acquisition unit 824, a main control unit 826, a power control unit 828, and memory units including RAM 820 and ROM 822.

The data processor 812 processes digital data that may be received from external sources or generated internally. The modulator 814 is coupled to the data processor 812 and modulates the digital data into digital baseband signals suitable for transmission. The spatial processor 816 processes spatial diversity signals for MIMO operation, implementing algorithms for spatial coding, beamforming, or other MIMO signal processing techniques.

The demodulator 818 is coupled to the spatial processor 816 and demodulates received digital baseband signals into digital data. The detection and acquisition unit 824 detects and acquires incoming signals, handling functions such as signal detection, timing recovery, and channel estimation. The main control unit 826 coordinates operation of the various processing components, while the power control unit 828 controls transmission power levels.

The memory units including RAM 820 and ROM 822 provide storage for program instructions, configuration data, and temporary data during system operation. The main control unit 826 may execute control algorithms stored in the memory units to coordinate overall system operation.

The first transceiver 830 is coupled to the digital circuit 810 and includes transmit and receive signal processing components. The transmit path includes a digital-to-analog converter (DAC) 832, a filter 834, and an amplifier 836. The receive path includes components for processing received RF signals, with the signal restructure unit positioned between the filter and mixer stages on the receive side.

The DAC 832 converts digital baseband signals from the digital circuit 810 to analog baseband signals. The filter 834 is coupled to the DAC 832 and filters the analog baseband signals to remove unwanted frequency components and provide spectral shaping. The amplifier 836 is coupled to the filter 834 and amplifies the filtered analog baseband signals to appropriate levels for further processing.

The output of the amplifier 836 is provided to the signal restructure unit 880, demonstrating the positioning of the restructure unit between the amplifier and mixer stages in the transmit signal chain. This configuration allows signal restructuring to occur after baseband amplification but before frequency up-conversion.

The second transceiver 860 is coupled to the digital circuit 810 and has a similar architecture to the first transceiver 830. The transmit path includes a DAC 862, a filter 864, and an amplifier 866. The receive path includes corresponding receive components with the signal restructure unit positioned between the filter and mixer stages on the receive side.

The components of the second transceiver 860 perform similar functions to their counterparts in the first transceiver 830. The DAC 862 converts digital baseband signals to analog baseband signals, the filter 864 provides spectral shaping, and the amplifier 866 amplifies the filtered signals. The output of the amplifier 866 is also provided to the signal restructure unit 880 for signal processing.

The signal restructure unit 880 is positioned in the baseband portion of the signal chain for both transmit and receive operations. On the transmit side, the signal restructure unit 880 is positioned between the amplifiers and mixers of the transceivers, processing baseband signals before frequency up-conversion. On the receive side, the signal restructure unit processes baseband signals after frequency down-conversion. The signal restructure unit coupled to the receivers can be different restructure units, depending on the specific system implementation and requirements.

For transmit operation, the signal restructure unit 880 receives amplified baseband signals from the amplifiers 836 and 866 of the first and second transceivers respectively, and provides phase-controlled baseband signals to downstream mixers. The signal restructure unit 880 processes these signals to generate restructured baseband signals with controlled phase relationships before frequency up-conversion takes place.

For receive operation, the signal restructure unit processes baseband signals that have been frequency down-converted from RF to baseband frequencies. The restructure unit processes these received baseband signals to maintain the appropriate phase relationships for proper MIMO operation. This baseband operation ensures that the phase relationships established during transmission are properly maintained during reception.

The signal restructure unit provides in-phase restructured signals when processing sum signals, enabling common-mode operation, and provides anti-phase restructured signals when processing difference signals, enabling differential-mode operation. The restructured signals are then provided to appropriate downstream components in both transmit and receive signal paths.

Following the signal restructure unit 880 and mixers, the transmit signal path includes mixers 838 and 868, power amplifiers 839 and 869, and RF switches 840 and 870. The mixers 838 and 868 perform frequency up-conversion using transmit local oscillator signals TX_LO to translate the restructured baseband signals to the desired RF transmission frequency.

The power amplifiers 839 and 869 amplify the up-converted signals to the required power levels for transmission. The RF switches 840 and 870 provide switching control for the respective signal paths, enabling transmit/receive switching and system control functions.

The MIMO antenna 890 is coupled to the output of the RF switches and receives the amplified restructured RF signals for radiation. The antenna 890 operates in different modes based on the phase relationships of the restructured signals provided by the signal restructure unit 880 for generation of uncorrelated MIMO signals from the single antenna structure.

Operating at baseband frequencies may simplify the restructure unit manufacturing since it eliminates the need to handle high-frequency RF signals and their associated challenges such as parasitic effects, impedance matching at RF frequencies, and high-frequency circuit design complexities. Additionally, baseband processing enables easier integration with digital signal processing functions, allowing for potential hybrid implementations where some restructuring functions could be performed digitally while others remain in the analog domain. This methodology provides maximum design flexibility and optimization opportunities.

The RF communication system 800 operates similarly to other embodiments, with the primary difference being the baseband positioning of the signal restructure unit 880. During transmission, digital baseband signals are processed by the digital circuit 810 and converted to analog baseband signals by the transceivers up to the amplifier stage. The signal restructure unit 880 then processes these baseband signals to create the appropriate phase relationships before frequency up-conversion and final amplification for transmission through the antenna 890.

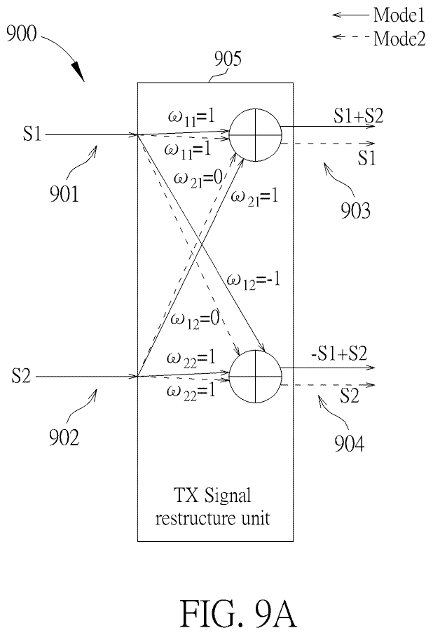

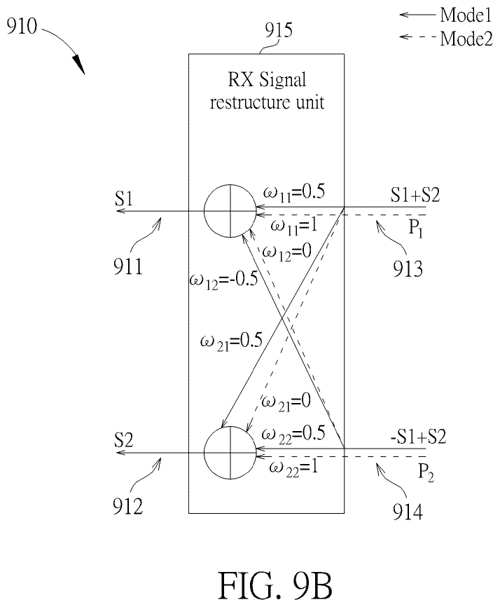

FIG. 9A depicts a TX signal restructure unit 900 according to an embodiment of the present invention. The TX restructure unit 900 is implemented as a digital circuit, which receives two input signals and generates restructured output signals through mathematical transformation operations performed in the digital domain. The TX restructure unit 900 may be placed in the digital portion of the RF signal chain.

The TX restructure unit 900 includes a first input port 901 that receives a first input signal S1, and a second input port 902 that receives a second input signal S2. The TX restructure unit 900 further includes a first output port 903 that outputs a first restructured signal, and a second output port 904 that outputs a second restructured signal.

The TX restructure unit 900 also includes a signal processing circuit 905 that implements a configurable weighting matrix with four weighting elements. A first weighting element ω11 may be applied to the first input signal S1 for generating the first restructured signal, and a second weighting element ω12 may be applied to the first input signal S1 for generating the second restructured signal. Similarly, a third weighting element ω21 may be applied to the second input signal S2 for generating the first restructured signal, and a fourth weighting element ω22 may be applied to the second input signal S2 for generating the second restructured signal.

The TX restructure unit 900 can be configured to operate in two distinct modes, namely mode1 and mode2. The first weighting element ω11 and the fourth weighting element ω22 are always set to 1. The second weighting element ω12 may be set to −1 in mode1 or 0 in mode2 based on mode selection. The third weighting element ω21 may be set to 1 in mode1 or 0 in mode2 based on mode selection.

In mode1, with ω11=1, ω12=−1, ω21=1, and ω22=1, the configuration can result in output signals of S1+S2 at the first output port 903 and −S1+S2 at the second output port 904. The mathematical expressions for these outputs are:

$$First output : ω 11 \times S 1 + ω 21 \times S 2 = 1 \times S 1 + 1 \times S 2 = S 1 + S 2 ; \\ Second output : ω12 \times S 1 + ω 22 \times S 2 = ( - 1 ) \times S 1 + 1 \times S 2 = - S 1 + S 2 .$$

In mode2, with ω11=1, ω12=0, ω21=0, and ω22=1, the configuration can produce output signals of S1 at the first output port 903 and S2 at the second output port 904. The mathematical expressions for these outputs are:

$$First output : ω11 \times S 1 + ω 21 \times S 2 = 1 \times S 1 + 0 \times S 2 = S 1 ; \\ Second output : ω12 \times S 1 + ω 22 \times S 2 = 0 \times S 1 + 1 \times S 2 = S 2 .$$

The signal processing circuit 905 may perform combining operations using summing elements that mathematically combine the weighted input signals according to the configured mode. This digital implementation may enable the conversion of single-ended input signals S1 and S2 into common-mode and differential-mode output signals, which can facilitate MIMO signal generation from one or more antenna element while avoiding RF front-end losses through baseband processing.

The restructure unit 900 can be implemented using digital signal processing techniques to avoid insertion losses typically associated with analog RF processing components. The digital implementation permits precise control of signal relationships and enables real-time reconfiguration of operational parameters through software control of the weighting coefficients and mode selection.

In operation, the signal restructure unit 900 receives independent data streams S1 and S2 from separate transmission channels and transforms these signals into sum and difference components suitable for driving MIMO antenna elements. The restructured signals output at ports 903 and 904 may be subsequently processed by digital-to-analog converters and RF transmission chains before being applied to antenna elements.

The mode selection capability allows the restructure unit 900 to adapt its operation based on varying channel conditions or system requirements. This reconfigurability may be controlled through a mode selection interface that switches between predetermined coefficient configurations, enabling optimization of MIMO antenna performance under different operational scenarios.

The signal restructure unit 900 can be integrated within the digital baseband processing section of a RF communication system, positioned between digital signal processors performing modulation functions and downstream analog processing components. This placement facilitates the signal restructuring operations while maintaining compatibility with existing digital processing architectures commonly employed in wireless communication systems.

FIG. 9B depicts an RX signal restructure unit 910 according to an embodiment of the present invention. The RX restructure unit 910 performs the reverse operation of the TX signal restructure unit 900 shown in FIG. 9A. The RX restructure unit 910 is implemented as a digital circuit that receives restructured input signals and recovers the original data streams through mathematical transformation operations performed in the digital domain. The RX restructure unit 910 may be placed in the digital portion of the RF signal chain for signal recovery operations.

The RX restructure unit 910 includes a first input port 913 that receives a first input signal S1+S2 (P1), and a second input port 914 that receives a second input signal-S1+S2 (P2). The unit further includes a first output port 911 that outputs a first recovered signal S1, and a second output port 912 that outputs a second recovered signal S2.

The RX restructure unit 910 includes a signal processing circuit 915 that implements a configurable weighting matrix with four weighting elements for signal recovery operations. A first weighting element ω11 may be applied to the first input signal for generating the first recovered signal, and a second weighting element ω12 may be applied to the first input signal for generating the second recovered signal. Similarly, a third weighting element ω21 may be applied to the second input signal for generating the first recovered signal, and a fourth weighting element ω22 may be applied to the second input signal for generating the second recovered signal.

The RX restructure unit 910 operates in two distinct modes, mode1 and mode2, corresponding to the operational modes of the transmitting TX restructure unit. The first weighting element ω11 may be set to 0.5 in mode1 or 1 in mode2 based on mode selection. The second weighting element ω12 may be set to −0.5 in mode1 or 0 in mode2 based on mode selection. The third weighting element ω21 may be set to 0.5 in mode1 or 0 in mode2 based on mode selection. The fourth weighting element ω22 may be set to 0.5 in mode1 or 1 in mode2 based on mode selection.

In mode1, with ω11=0.5, ω12=−0.5, ω21=0.5, and ω22=0.5, the configuration can result in recovered signals of S1 at the first output port 911 and S2 at the second output port 912. The mathematical expressions for these outputs are:

$$First output : ω 11 \times ( S 1 + S 2 ) + ω12 \times ( - S 1 + S 2 ) = 0.5 \times ( S 1 + S 2 ) + ( - 0.5 ) \times ( - S 1 + S 2 ) = 0.5 S 1 + 0.5 S 2 + 0 \text{.5} S 1 - 0.5 S 2 = S 1 ; \\ Second output : ω21 \times ( S 1 + S 2 ) + ω22 \times ( - S 1 + S 2 ) = 0.5 \times ( S 1 + S 2 ) + 0.5 \times ( - S 1 + S 2 ) = 0.5 S 1 + 0.5 S 2 - 0.5 S 1 + 0.5 S 2 = S 2$$

In mode2, with ω11=1, ω12=0, ω21=0, and ω22=1, the configuration can produce direct-through signals of S1+S2 at the first output port 911 and −S1+S2 at the second output port 912. The mathematical expressions for these outputs are:

$$First output : ω11 \times ( S 1 + S 2 ) + ω12 \times ( - S 1 + S 2 ) = 1 \times ( S 1 + S 2 ) + 0 \times ( - S 1 + S 2 ) = S 1 + S 2 ; \\ Second output : ω21 \times ( S 1 + S 2 ) + ω22 \times ( - S 1 + S 2 ) = 0 \times ( S 1 + S 2 ) + 1 \times ( - S 1 + S 2 ) = - S 1 + S 2.$$

The signal processing circuit 915 may perform combining operations using summing elements that mathematically combine the weighted input signals according to the configured mode. This digital implementation may enable the recovery of original single-ended signals S1 and S2 from common-mode and differential-mode input signals, which can facilitate MIMO signal reception and decoding while avoiding RF front-end losses through baseband processing.

The restructure unit 910 can be implemented using digital signal processing techniques, thereby avoiding insertion losses typically associated with analog RF processing components. The digital implementation permits precise control of signal relationships and enables real-time reconfiguration of operational parameters through software control of the weighting coefficients and mode selection.

In operation, the signal restructure unit 910 receives restructured signals from upstream analog-to-digital converters and RF reception chains that have processed signals received from MIMO antenna elements. The unit transforms these combined signals back into the original independent data streams S1 and S2 for separate reception channels. The recovered signals output at ports 911 and 912 may be subsequently processed by digital signal processors performing demodulation functions.

The mode selection capability allows the restructure unit 910 to adapt its operation to match the corresponding transmission mode used by the TX restructure unit, ensuring proper signal recovery. This reconfigurability may be controlled through a mode selection interface that switches between predetermined coefficient configurations, enabling optimization of MIMO antenna performance under different operational scenarios.

The signal restructure unit 910 can be integrated within the digital baseband processing section of a RF communication system, positioned between upstream analog processing components and digital signal processors performing demodulation functions. This placement facilitates the signal recovery operations while maintaining compatibility with existing digital processing architectures commonly employed in wireless communication systems.

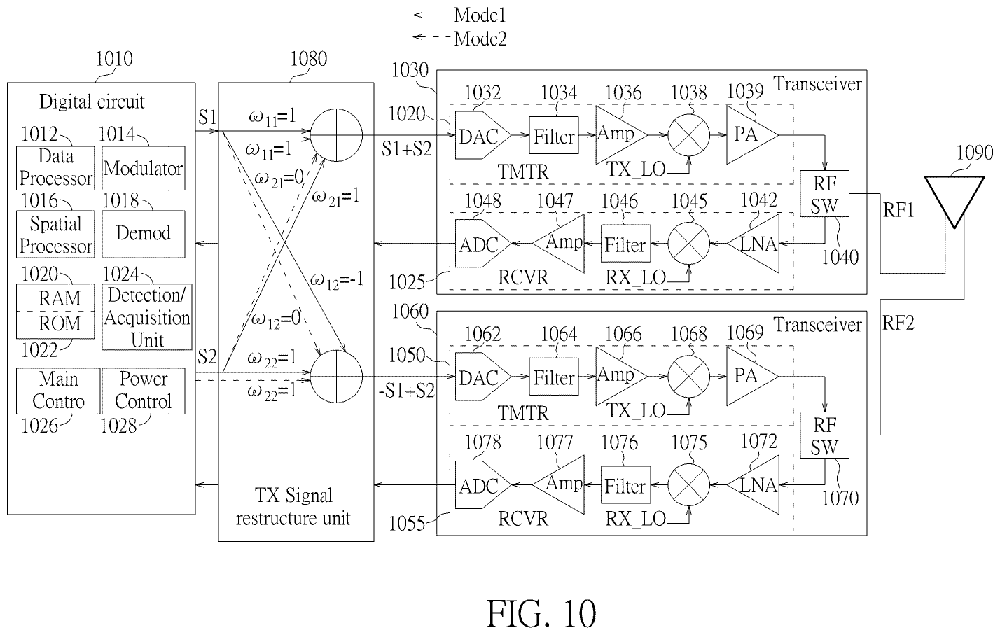

FIG. 10 depicts an RF communication system 1000 according to an embodiment of the present invention, showing a complete MIMO communication system that integrates digital processing, transceivers, and a TX signal restructure unit with antenna for enhanced transmission performance. The RF communication system 1000 demonstrates the TX signal restructure unit being implemented within a comprehensive communication architecture for baseband signal restructuring. The RF communication system 1000 includes a digital circuit 1010, transceivers 1030 and 1060, a TX signal restructure unit 1080, and an antenna 1090.

The digital circuit 1010 (e.g., a modem) can generate and process digital baseband signals. The digital circuit 1010 includes several functional blocks that work together to handle digital signal processing operations. The digital circuit 1010 includes a data processor 1012, a modulator 1014, a spatial processor 1016, a demodulator 1018, a detection and acquisition unit 1024, a main control unit 1026, a power control unit 1028, and memory units including random access memory (RAM) 1020 and read-only memory (ROM) 1022.

The data processor 1012 processes digital data that may be received from external sources or generated internally. The data processor 1012 handles various data formatting, encoding, and protocol processing functions necessary for communication operations. The modulator 1014 is coupled to the data processor 1012 and modulates the digital data into digital baseband signals suitable for transmission. The modulator 1014 may implement various modulation schemes such as QPSK, QAM, or other appropriate modulation techniques depending on the communication standard and requirements. The spatial processor 1016 processes spatial diversity signals for MIMO operation. The spatial processor 1016 may implement algorithms for spatial coding, beamforming, or other MIMO signal processing techniques that enable the generation of independent data streams S1 and S2 for transmission through the TX signal restructure unit 1080. The demodulator 1018 is coupled to the spatial processor 1016 and demodulates received digital baseband signals into digital data. The demodulator 1018 performs the inverse operations of the modulator 1014, recovering the transmitted data from the received signals.

The detection and acquisition unit 1024 detects and acquires incoming signals. It may handle functions such as signal detection, timing recovery, frequency offset estimation, and channel estimation necessary for proper signal reception. The main control unit 1026 coordinates operation of the data processor 1012, modulator 1014, spatial processor 1016, and demodulator 1018. The main control unit 1026 provides overall system control and coordination between the various functional blocks, including mode selection control for the TX signal restructure unit 1080. The power control unit 1028 controls transmission power levels of the system. The power control unit 1028 may adjust transmit power based on channel conditions, regulatory requirements, or system optimization algorithms.

The memory units including RAM 1020 and ROM 1022 provide storage for program instructions, configuration data, and temporary data storage during system operation. The main control unit 1026 may execute control algorithms stored in the memory units to coordinate system operation and control the operational modes of the TX signal restructure unit 1080.

The TX signal restructure unit 1080 is coupled between the digital circuit 1010 and both transceivers 1030 and 1060. The TX signal restructure unit 1080 receives independent digital baseband signals S1 and S2 from the digital circuit 1010 and generates restructured output signals for transmission through the transceivers. The TX signal restructure unit 1080 implements the digital signal processing operations described in FIG. 9A, performing mathematical transformation operations to convert single-ended input signals into common-mode and differential-mode output signals.

The TX signal restructure unit 1080 can be configured to operate in two distinct modes. In mode1, the TX signal restructure unit generates output signals S1+S2 and −S1+S2 through configurable weighting elements ω11=1, ω12=−1, ω21=1, and ω22=1. In mode2, the TX signal restructure unit 1080 generates output signals S1 and S2 through reconfigured weighting elements ω11=1, ω12=0, ω21=0, and ω22=1. The mode selection may be controlled by the main control unit 1026 based on channel conditions or system requirements.

The first transceiver 1030 is coupled to the TX signal restructure unit 1080. The first transceiver 1030 converts restructured digital baseband signals to first RF signals and converts received first RF signals to digital baseband signals. The first transceiver 1030 includes a transmitter unit (TMTR) 1020 and a receiver unit (RCVR) 1025.

The transmitter unit 1020 includes a digital-to-analog converter (DAC) 1032, a filter 1034, an amplifier 1036, a mixer 1038, a power amplifier (PA) 1039, and an RF switch 1040. The transmitter unit 1020 converts restructured digital baseband signals from the TX signal restructure unit 1080 to RF signals for transmission.

The DAC 1032 converts the restructured digital baseband signals to analog baseband signals. The filter 1034 is coupled to the DAC 1032 and filters the analog baseband signals to remove unwanted frequency components and provide spectral shaping. The amplifier 1036 is coupled to the filter 1034 and amplifies the filtered analog baseband signals to appropriate levels for further processing. The mixer 1038 is coupled to the amplifier 1036 and converts the amplified baseband signals to RF frequency using a transmit local oscillator signal TX_LO. The mixer 1038 performs frequency up-conversion to translate the baseband signals to the desired RF transmission frequency. The power amplifier (PA) 1039 is coupled to the mixer 1038 and amplifies the converted signals to generate the first RF signals at the required power levels for transmission. The RF switch 1040 is coupled between the power amplifier 1039 and the antenna 1090, providing control over signal routing and isolation when needed.

The receiver unit 1025 includes a low noise amplifier (LNA) 1042, a mixer 1045, a filter 1046, an amplifier 1047, and an analog-to-digital converter (ADC) 1048. The receiver unit RCVR 1025 converts received RF signals to digital baseband signals. The LNA 1042 amplifies received incoming RF signals while adding minimal noise to preserve signal quality. The mixer 1045 is coupled to the LNA 1042 and converts the amplified RF signals to baseband frequency using a receive local oscillator signal RX_LO. The filter 1046 is coupled to the mixer 1045 and filters the converted signals to remove unwanted frequency components and provide channel selectivity. The amplifier 1047 is coupled to the filter 1046 and amplifies the filtered signals to appropriate levels for analog-to-digital conversion. The ADC 1048 is coupled to the amplifier 1047 and converts the amplified analog signals to digital baseband signals for processing by the digital circuit 1010.

The second transceiver 1060 is also coupled to the TX signal restructure unit 1080. The second transceiver 1060 has a similar architecture to the first transceiver 1030 and converts restructured digital baseband signals to second RF signals and converts received second RF signals to digital baseband signals. The second transceiver 1060 includes a transmitter unit 1050 and a receiver unit 1055.

The transmitter unit 1050 includes a DAC 1062, a filter 1064, an amplifier 1066, a mixer 1068, a power amplifier 1069, and an RF switch 1070. These components perform similar functions to their counterparts in the first transceiver 1030, processing the second channel of restructured digital baseband signals for transmission.

The receiver unit 1055 includes an LNA 1072, a mixer 1075, a filter 1076, an amplifier 1077, and an ADC 1078. These components process received RF signals for the second channel, converting them to digital baseband signals for processing by the digital circuit 1010.

The MIMO antenna 1090 is coupled to both the first transceiver 1030 and the second transceiver 1060. The MIMO antenna 1090 receives RF signals RF1 and RF2 from the first transceiver 1030 and the second transceiver 1060 respectively. The antenna 1090 radiates the RF signals generated from the restructured baseband signals and receives incoming RF signals. The antenna 1090 operates in different modes based on the restructured signals provided by the TX signal restructure unit 1080, enabling MIMO transmission with enhanced isolation and reduced antenna size compared to traditional MIMO antenna systems.

The RF communication system 1000 enables MIMO signal transmission through a single antenna element by utilizing the TX signal restructure unit 1080 to convert independent data streams into common-mode and differential-mode signals in the digital domain. This strategy minimizes RF front-end losses as it enables reconfigurable MIMO operation adaptable to varying channel conditions and system requirements.

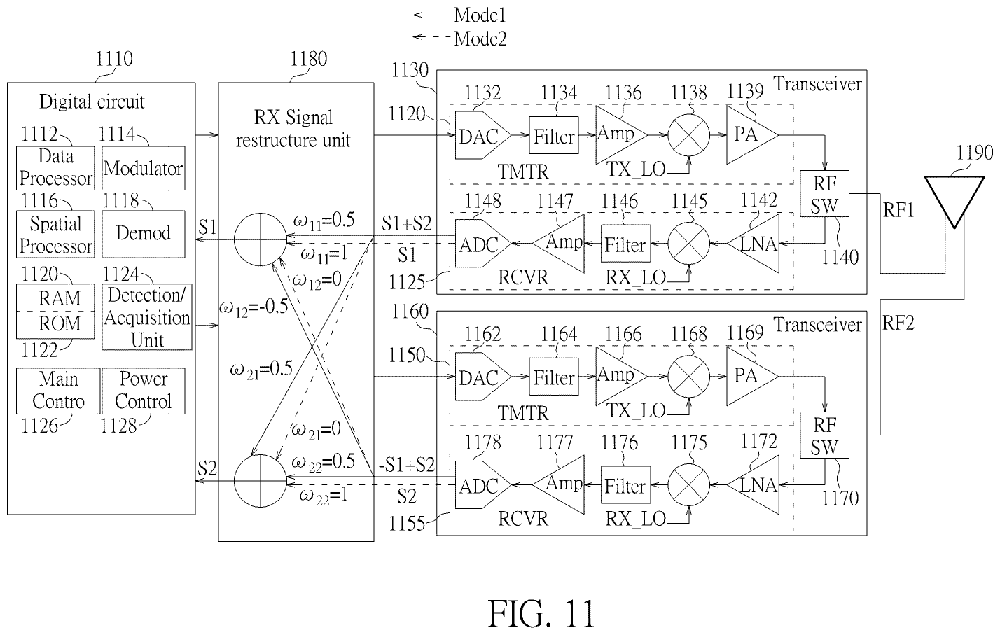

FIG. 11 depicts an RF communication system 1100 according to an embodiment of the present invention, showing a complete MIMO communication system that integrates digital processing, transceivers, and an RX signal restructure unit with antenna for enhanced reception performance. The RF communication system 1100 demonstrates the RX signal restructure unit being implemented within a comprehensive communication architecture for signal recovery and processing. The RF communication system 1100 includes a digital circuit 1110, transceivers 1130 and 1160, an RX signal restructure unit 1180, and an antenna 1190.

The digital circuit 1110 (e.g., a modem) can generate and process digital baseband signals. The digital circuit 1110 includes several functional blocks that work together to handle digital signal processing operations. The digital circuit 1110 includes a data processor 1112, a modulator 1114, a spatial processor 1116, a demodulator 1118, a detection and acquisition unit 1124, a main control unit 1126, a power control unit 1128, and memory units including random access memory (RAM) 1120 and read-only memory (ROM) 1122.

The data processor 1112 processes digital data that may be received from external sources or generated internally. The data processor 1112 handles various data formatting, encoding, and protocol processing functions necessary for communication operations. The modulator 1114 is coupled to the data processor 1112 and modulates the digital data into digital baseband signals suitable for transmission. The modulator 1114 may implement various modulation schemes such as QPSK, QAM, or other appropriate modulation techniques depending on the communication standard and requirements. The spatial processor 1116 processes spatial diversity signals for MIMO operation. The spatial processor 1116 may implement algorithms for spatial coding, beamforming, or other MIMO signal processing techniques that enable the processing of recovered data streams S1 and S2 from the RX signal restructure unit 1180. The demodulator 1118 is coupled to the spatial processor 1116 and demodulates received digital baseband signals into digital data. The demodulator 1118 performs the inverse operations of the modulator 1114, recovering the transmitted data from the received signals.

The detection and acquisition unit 1124 detects and acquires incoming signals. It may handle functions such as signal detection, timing recovery, frequency offset estimation, and channel estimation necessary for proper signal reception. The main control unit 1126 coordinates operation of the data processor 1112, modulator 1114, spatial processor 1116, and demodulator 1118. The main control unit 1126 provides overall system control and coordination between the various functional blocks, including mode selection control for the RX signal restructure unit 1180. The power control unit 1128 controls transmission power levels of the system. The power control unit 1128 may adjust transmit power based on channel conditions, regulatory requirements, or system optimization algorithms.

The memory units including RAM 1120 and ROM 1122 provide storage for program instructions, configuration data, and temporary data storage during system operation. The main control unit 1126 may execute control algorithms stored in the memory units to coordinate system operation and control the operational modes of the RX signal restructure unit 1180.

The RX signal restructure unit 1180 is coupled between both transceivers 1130 and 1160 and the digital circuit 1110. The RX signal restructure unit 1180 receives restructured digital baseband signals from the transceivers and generates recovered output signals S1 and S2 for processing by the digital circuit 1110. The RX signal restructure unit 1180 implements the digital signal processing operations described in FIG. 9B, performing mathematical transformation operations to convert common-mode and differential-mode input signals back into single-ended output signals.

The RX signal restructure unit 1180 receives input signals S1+S2 and −S1+S2 (in mode 1) or S1 and S2 (in mode 2) from the transceivers after analog-to-digital conversion. The RX signal restructure unit 1180 can be configured to operate in two distinct modes corresponding to the transmission modes. In mode1, the RX signal restructure unit 1180 processes the input signals S1+S2 and −S1+S2 through configurable weighting elements ω11=0.5, ω12=−0.5, ω21=0.5, and ω22=0.5 to recover the original signals S1 and S2. In mode2, the RX signal restructure unit 1180 processes the input signals S1 and S2 through reconfigured weighting elements ω11=1, ω12=0, ω21=0, and ω22=1 to recover the original signals S1 and S2. The mode selection may be controlled by the main control unit 1126 to match the corresponding transmission mode used at the transmitter.

The first transceiver 1130 is coupled between the antenna 1190 and the RX signal restructure unit 1180. The first transceiver 1130 converts digital baseband signals to first RF signals and converts received first RF signals RF1 to digital baseband signals. The first transceiver 1130 includes a transmitter unit (TMTR) 1120 and a receiver unit (RCVR) 1125.

The transmitter unit 1120 includes a digital-to-analog converter (DAC) 1132, a filter 1134, an amplifier 1136, a mixer 1138, a power amplifier (PA) 1139, and an RF switch 1140. The transmitter unit 1120 converts digital baseband signals to RF signals for transmission.

The DAC 1132 converts the digital baseband signals to analog baseband signals. The filter 1134 is coupled to the DAC 1132 and filters the analog baseband signals to remove unwanted frequency components and provide spectral shaping. The amplifier 1136 is coupled to the filter 1134 and amplifies the filtered analog baseband signals to appropriate levels for further processing. The mixer 1138 is coupled to the amplifier 1136 and converts the amplified baseband signals to RF frequency using a transmit local oscillator signal TX_LO. The mixer 1138 performs frequency up-conversion to translate the baseband signals to the desired RF transmission frequency. The power amplifier (PA) 1139 is coupled to the mixer 1138 and amplifies the converted signals to generate the first RF signals at the required power levels for transmission. The RF switch 1140 is coupled between the power amplifier 1139 and the antenna 1190, providing control over signal routing and isolation when needed.

The receiver unit 1125 includes a low noise amplifier (LNA) 1142, a mixer 1145, a filter 1146, an amplifier 1147, and an analog-to-digital converter (ADC) 1148. The receiver unit RCVR 1125 converts received RF signals RF1 to digital baseband signals for processing by the RX signal restructure unit 1180. The LNA 1142 amplifies received incoming RF signals RF1 while adding minimal noise to preserve signal quality. The mixer 1145 is coupled to the LNA 1142 and converts the amplified RF signals to baseband frequency using a receive local oscillator signal RX_LO. The filter 1146 is coupled to the mixer 1145 and filters the converted signals to remove unwanted frequency components and provide channel selectivity. The amplifier 1147 is coupled to the filter 1146 and amplifies the filtered signals to appropriate levels for analog-to-digital conversion. The ADC 1148 is coupled to the amplifier 1147 and converts the amplified analog signals to digital baseband signals for processing by the RX signal restructure unit 1180.

The second transceiver 1160 is also coupled between the antenna 1190 and the RX signal restructure unit 1180. The second transceiver 1160 has a similar architecture to the first transceiver 1130 and converts digital baseband signals to second RF signals and converts received second RF signals RF2 to digital baseband signals. The second transceiver 1160 includes a transmitter unit 1150 and a receiver unit 1155.

The transmitter unit 1150 includes a DAC 1162, a filter 1164, an amplifier 1166, a mixer 1168, a power amplifier 1169, and an RF switch 1170. These components perform similar functions to their counterparts in the first transceiver 1130, processing digital baseband signals for transmission.

The receiver unit 1155 includes an LNA 1172, a mixer 1175, a filter 1176, an amplifier 1177, and an ADC 1178. These components process received RF signals RF2 for the second channel, converting them to digital baseband signals for processing by the RX signal restructure unit 1180.

The MIMO antenna 1190 is coupled to both the first transceiver 1130 and the second transceiver 1160. The antenna 1190 receives incoming RF signals and provides RF signals RF1 and RF2 to the first transceiver 1130 and the second transceiver 1160 respectively. The antenna 1190 operates to receive MIMO signals by using common-mode and differential-mode operations, enabling the recovery of independent data streams through the RX signal restructure unit 1180.

The RF communication system 1100 enables MIMO signal reception through a single antenna element by utilizing the RX signal restructure unit 1180 to convert restructured signals back into independent data streams S1 and S2 in the digital domain. This approach avoids RF front-end losses while providing reconfigurable MIMO operation that can adapt to varying channel conditions and recover signals transmitted using different operational modes.

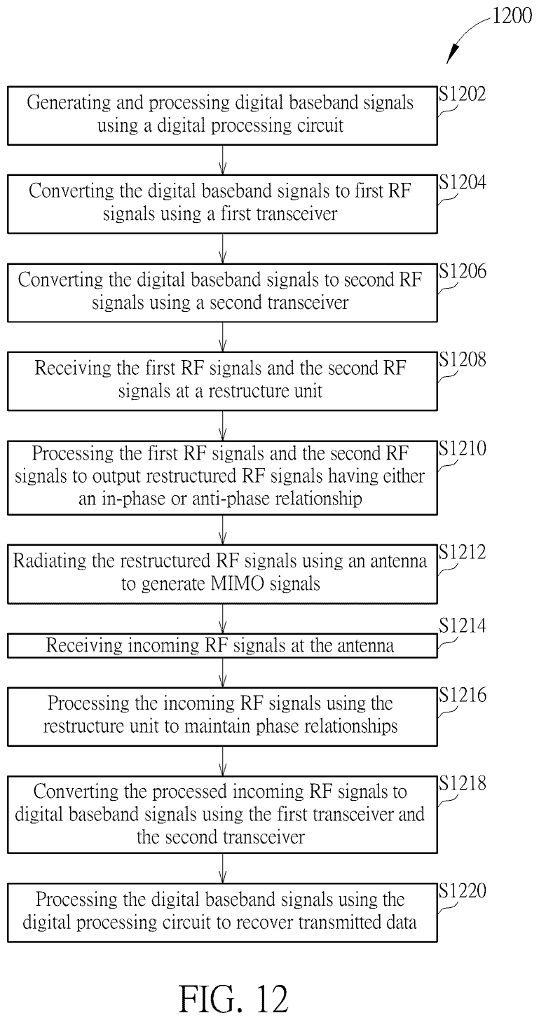

FIG. 12 depicts a flow diagram showing a method 1200 of operating a radio frequency (RF) communication system for MIMO communication according to an embodiment. The method 1200 includes the following steps:
S1202: Generating and processing digital baseband signals using a digital processing circuit;
S1204: Converting the digital baseband signals to first RF signals using a first transceiver;
S1206: Converting the digital baseband signals to second RF signals using a second transceiver;
S1208: Receiving the first RF signals and the second RF signals at a restructure unit;
S1210: Processing the first RF signals and the second RF signals to output restructured RF signals having either an in-phase or anti-phase relationship;
S1212: Radiating the restructured RF signals using an antenna to generate MIMO signals;
S1214: Receiving incoming RF signals at the antenna;
S1216: Processing the incoming RF signals using the restructure unit to maintain phase relationships;
S1218: Converting the processed incoming RF signals to digital baseband signals using the first transceiver and the second transceiver; and
S1220: Processing the digital baseband signals using the digital processing circuit to recover transmitted data.

The method 1200 begins with step S1202, which includes generating and processing digital baseband signals using a digital processing circuit that includes a data processor, modulator, spatial processor, and associated control units. The digital processing circuit handles data formatting, modulation, and spatial diversity processing for MIMO operation. The data processor receives and formats digital data from external sources, while the modulator converts the formatted data into modulated baseband signals suitable for transmission. The spatial processor implements MIMO signal processing algorithms to enable spatial diversity and improved data throughput.

Step S1204 involves converting the digital baseband signals to first RF signals using a first transceiver. This conversion process involves multiple stages of signal processing, beginning with digital-to-analog conversion to transform the digital baseband signals into analog form. The analog signals are then filtered to remove unwanted frequency components and provide spectral shaping. An amplifier increases the signal levels to appropriate values for frequency conversion, followed by a mixer that performs frequency up-conversion using a local oscillator signal to translate the baseband signals to the desired RF transmission frequency. Finally, a power amplifier boosts the converted signals to the required power levels for transmission.

Step S1206 involves converting the digital baseband signals to second RF signals using a second transceiver having similar architecture to the first transceiver. The second transceiver performs parallel signal processing operations including digital-to-analog conversion, filtering, amplification, frequency up-conversion, and power amplification to generate a second channel of RF signals for MIMO operation. This parallel processing enables the system to generate multiple signal streams that can be processed by the restructure unit to create the desired phase relationships for MIMO transmission.

Step S1208 involves receiving the first RF signals and the second RF signals at a restructure unit coupled between the transceivers and antenna. The restructure unit includes multiple ports that interface with the outputs of both transceivers, allowing it to receive and process signals from both transmission channels. The restructure unit is positioned strategically in the signal path to enable optimal signal processing while maintaining signal integrity and minimizing losses.

Step S1210 involves processing the first RF signals and the second RF signals to output restructured RF signals having controlled phase relationships. The restructure unit analyzes the input signals and applies appropriate phase transformations based on the signal types. When the second RF signals include a sum signal, the restructure unit provides in-phase restructured signals to enable common-mode operation of the antenna. When the first RF signals include a difference signal, the restructure unit provides anti-phase restructured signals to enable differential-mode operation of the antenna. This phase control enables the generation of uncorrelated MIMO signals from a single antenna structure.

Step S1212 involves radiating the restructured RF signals using an antenna coupled to the restructure unit. The antenna receives the phase-controlled signals from the restructure unit and radiates electromagnetic energy based on the specific phase relationships provided. The different phase relationships create distinct radiation patterns that enable MIMO operation, allowing the single antenna to effectively generate multiple uncorrelated signal streams that can be distinguished by receiving systems.

Step S1214 involves receiving incoming RF signals at the antenna from external sources. The antenna captures electromagnetic energy from the surrounding environment and converts it into electrical signals that can be processed by the communication system. The incoming signals may contain MIMO-encoded information transmitted from other communication systems, requiring proper phase relationship processing to enable signal separation and decoding.

Step S1216 involves processing the incoming RF signals using the restructure unit to maintain appropriate phase relationships for proper MIMO signal separation. The restructure unit operates in a bidirectional manner, processing received signals to ensure that the phase relationships established during transmission are preserved during reception. This processing enables the system to properly separate and decode MIMO signals.

Step S1218 involves converting the processed incoming RF signals to digital baseband signals using the first transceiver and second transceiver. Each transceiver performs a series of signal processing operations in reverse order compared to the transmission path. The received RF signals are first amplified using low-noise amplifiers to improve signal quality while minimizing noise addition. Mixers then perform frequency down-conversion using local oscillator signals to translate the RF signals back to baseband frequencies. The down-converted signals are filtered to remove unwanted frequency components and provide channel selectivity, followed by additional amplification to prepare the signals for analog-to-digital conversion. Finally, analog-to-digital converters transform the analog baseband signals back into digital form for processing by the digital circuit.

Step S1220 involves processing the digital baseband signals using the digital processing circuit to recover transmitted data. The digital processing operations include demodulation to reverse the modulation process applied during transmission, spatial signal processing to separate and decode MIMO signal streams, and data recovery operations to extract the original transmitted information. The demodulator works in conjunction with the spatial processor to properly separate the multiple signal streams and recover the transmitted data with minimal errors.

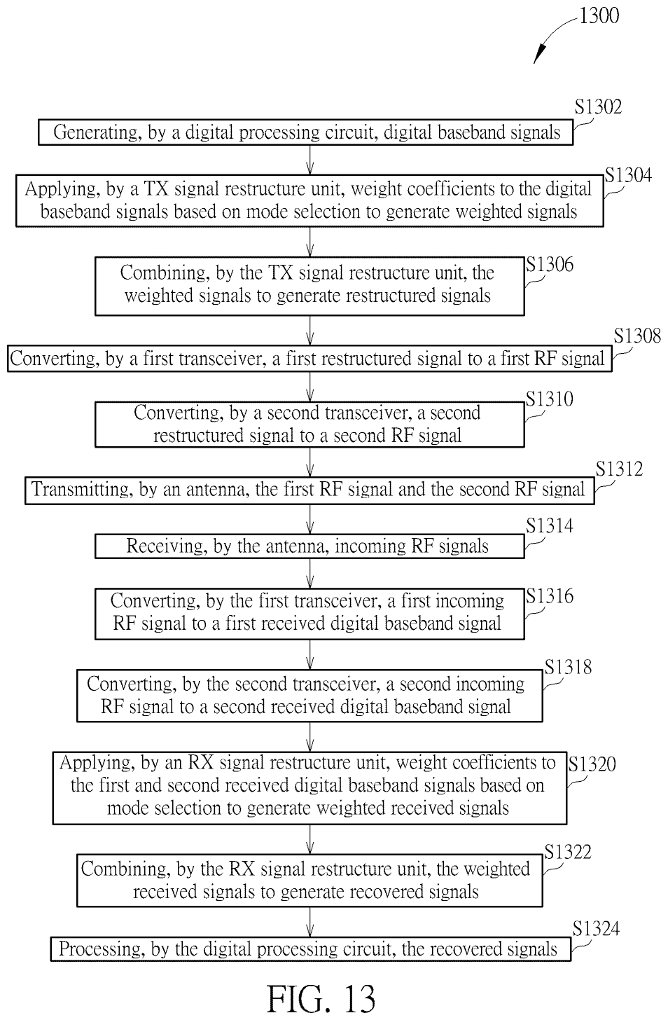

FIG. 13 depicts a flow diagram showing a method 1300 of operating a radio frequency (RF) communication system for MIMO communication according to an embodiment. The method 1300 includes the following steps:
S1302: Generating, by a digital processing circuit, digital baseband signals;
S1304: Applying, by a TX signal restructure unit, weight coefficients to the digital baseband signals based on mode selection to generate weighted signals;
S1306: Combining, by the TX signal restructure unit, the weighted signals to generate restructured signals;
S1308: Converting, by a first transceiver, a first restructured signal to a first RF signal;
S1310: Converting, by a second transceiver, a second restructured signal to a second RF signal;
S1312: Transmitting, by an antenna, the first RF signal and the second RF signal;
S1314: Receiving, by the antenna, incoming RF signals;
S1316: Converting, by the first transceiver, a first incoming RF signal to a first received digital baseband signal;
S1318: Converting, by the second transceiver, a second incoming RF signal to a second received digital baseband signal;
S1320: Applying, by an RX signal restructure unit, weight coefficients to the first and second received digital baseband signals based on mode selection to generate weighted received signals;
S1322: Combining, by the RX signal restructure unit, the weighted received signals to generate recovered signals; and
S1324: Processing, by the digital processing circuit, the recovered signals.

The method begins with Step S1302, which includes generating and processing digital baseband signals using a digital processing circuit that includes a data processor, modulator, spatial processor, and associated control units. The digital processing circuit handles data formatting, modulation, and spatial diversity processing for MIMO operation. The data processor receives and formats digital data from external sources or internal generation. The modulator converts the formatted data into modulated baseband signals using schemes such as QPSK or QAM. The spatial processor implements MIMO signal processing algorithms including spatial coding and beamforming to generate independent data streams S1 and S2 for enhanced transmission performance.

Step S1304 involves applying configurable weight coefficients to the digital baseband signals through a TX signal restructure unit. The restructure unit operates in different modes based on channel conditions and system requirements. The unit applies four distinct weighting elements to transform the input signals. A first weighting element (ω11) is applied to signal S1 for generating the first restructured output. A second weighting element (ω12) is applied to signal S1 for generating the second restructured output. Similarly, a third weighting element (ω21) is applied to signal S2 for the first output, while a fourth weighting element (ω22) is applied to signal S2 for the second output.

Step S1306 involves the mathematical combining operations performed by the TX signal restructure unit to generate restructured output signals. The unit operates in two distinct modes with different coefficient configurations. In Mode1, the weighting elements are configured as ω11=1, ω12=−1, ω21=1, and ω22=1. This configuration generates S1+S2 as the first restructured signal and −S1+S2 as the second restructured signal. In Mode2, the elements are reconfigured as ω11=1, ω12=0, ω21=0, and ω22=1. This alternate configuration produces S1 as the first output and S2 as the second output. The combining operations utilize summing elements to perform the mathematical transformations.

Step S1308 involves the conversion process for the first restructured signal to RF frequency through the first transceiver. The conversion begins with a digital-to-analog converter (DAC) that transforms the digital restructured signal into an analog baseband representation. A filter then processes the analog signal to remove unwanted frequency components and provide spectral shaping. An amplifier boosts the filtered signal to appropriate levels for further processing. A mixer performs frequency up-conversion using a transmit local oscillator signal to translate the baseband signal to the desired RF transmission frequency. Finally, a power amplifier amplifies the up-converted signal to generate the first RF signal at the required power levels for effective transmission.

Step S1310 involves a parallel conversion process for the second restructured signal through the second transceiver. The second transceiver employs identical processing stages to those used in the first transceiver. A digital-to-analog converter transforms the second restructured signal into analog form. Filtering removes unwanted frequency components from the analog signal. Amplification prepares the signal for frequency conversion. Up-conversion translates the signal to RF frequency using a local oscillator. Power amplification generates the second RF signal at the necessary transmission power levels.

Step S1312 involves the transmission of both RF signals through the antenna system. The antenna radiates the first and second RF signals as electromagnetic waves into the transmission medium. The antenna operates in different modes based on the phase relationships established by the restructured signals. This operational flexibility enables MIMO transmission with enhanced isolation between signal paths. The system achieves improved performance compared to traditional MIMO antenna configurations through reduced antenna size requirements and better signal separation.

Step S1314 involves the receive path by capturing incoming electromagnetic waves through the same antenna system. The antenna functions bidirectionally to receive RF signals transmitted from remote communication systems. The received electromagnetic energy is converted back into electrical signals. The antenna provides the captured RF signals as separate first and second incoming RF signals to the respective transceivers for further processing in the receive signal chain.

Step S1316 involves the conversion of the first incoming RF signal to digital baseband format through the first transceiver's receiver section. A low noise amplifier (LNA) first amplifies the weak incoming RF signal while adding minimal noise to preserve signal quality. A mixer then down-converts the amplified RF signal to baseband frequency using a receive local oscillator signal. Filtering removes unwanted frequency components and provides channel selectivity. An amplifier boosts the filtered signal to appropriate levels for digitization. Finally, an analog-to-digital converter (ADC) transforms the processed analog signal into the first received digital baseband signal.

Step S1318 follows the same conversion process for the second incoming RF signal through the second transceiver's receiver section. The second receiver processes the incoming RF signal through identical stages. Low noise amplification preserves signal integrity while boosting signal levels. Down-conversion translates the RF signal to baseband frequency. Filtering eliminates unwanted components. Amplification prepares the signal for analog-to-digital conversion. The ADC generates the second received digital baseband signal for subsequent processing.

Step S1320 involves applying weight coefficients to the received digital baseband signals through an RX signal restructure unit. The RX unit performs the inverse operations of the TX restructure unit to recover the original data streams. The unit receives different input signal combinations depending on the various channel conditions. In Mode1, the inputs are S1+S2 and −S1+S2 representing common-mode and differential-mode signals. In Mode2, the inputs are the direct signals S1 and S2. The RX unit applies corresponding weight coefficients including ω11=0.5, ω12=−0.5, ω21=0.5, and ω22=0.5 for Mode1 processing, or ω11=1, ω12=0, ω21=0, and ω22=1 for Mode2 processing.

Step S1322 involves the mathematical transformation operations that convert the received restructured signals back to the original single-ended format. The RX signal restructure unit executes inverse mathematical operations to those performed by the TX unit. These operations convert common-mode and differential-mode received signals back into independent single-ended data streams. The unit recovers the original signals S1 and S2 through precise coefficient application and signal combining. The recovered signals maintain the integrity of the original data streams transmitted by the remote system.

Step S1324 involves digital processing of the recovered signals by the digital processing circuit. A demodulator processes the recovered signals S1 and S2 to extract the transmitted digital data. The spatial processor handles MIMO signal processing and spatial diversity operations on the recovered data streams. A detection and acquisition unit performs critical functions including signal detection, timing recovery, frequency offset estimation, and channel estimation. The main control unit coordinates the overall system operation and manages mode selection for both TX and RX restructure units to ensure proper signal recovery and system optimization.

The terminology employed in the description of the various embodiments herein is intended for the purpose of describing particular embodiments and should not be construed as limiting. In the context of this description and the appended claims, the singular forms “a”, “an”, and “the” are intended to encompass plural forms as well, unless the context clearly indicates otherwise.

It should be understood that the term “and/or” as used herein is intended to encompass any and all possible combinations of one or more of the associated listed items. Furthermore, it should be noted that the terms “includes,” “including,” “comprises,” and/or “comprising,” when used in this specification, indicate the presence of stated features, integers, steps, operations, elements, and/or components, but do not exclude the presence or addition of one or more other features, integers, steps, operations, elements, components, and/or groups thereof.

Unless specifically stated otherwise, the term “some” refers to one or more. Various combinations using “at least one of” or “one or more of” followed by a list (e.g., A, B, or C) should be interpreted to include any combination of the listed items, including individual items and multiple items.

In the context of this disclosure, the terms “coupled,” “connected,” “connecting,” “electrically connected,” and similar expressions are used interchangeably to broadly denote the state of being electrically or electronically connected. Furthermore, an entity is deemed to be in “communication” with another entity (or entities) when it electrically transmits and/or receives information signals to/from the other entity, irrespective of whether these signals contain image/voice information or data/control information, and regardless of the signal type (analog or digital). It is important to note that this communication can occur through either wired or wireless means. The use of these terms is intended to encompass all forms of electrical or electronic connectivity relevant to the described embodiments.

The use of ordinal designators like “first,” “second,” and so forth in the specification and claims serves to differentiate between multiple instances of similarly named elements. These designators do not imply any inherent sequence, priority, or chronological order in the manufacturing process or functional relationship between elements. Rather, they are employed solely as a means of uniquely identifying and distinguishing between separate instances of elements that share a common name or description.

The directional terms used in the embodiments such as up, down, left, right, upper-side, down-side, in front of or behind are just the directions referring to the attached figures. Thus, the direction terms used in the present disclosure are for illustration, and are not intended to limit the scope of the present disclosure. It should be noted that the elements which are specifically described or labeled may exist in various forms for those skilled in the art.

As may be used throughout this specification and the appended claims, terms of approximation and degree such as “substantially,” “approximately,” “generally,” “essentially,” “nearly,” “about,” and similar expressions are used to account for variations in precision, manufacturing tolerances, measurement accuracy, environmental conditions, and inherent material properties that may affect the described features or characteristics. Such variations may range from ±20% in broader applications to progressively tighter tolerances of ±10%, ±5%, ±3%, ±2%, ±1%, or ±0.5% in more precise implementations. The specific degree of variation encompassed by these terms of approximation in any given context is informed by the nature of the component, relationship, or parameter being described, the technical requirements of the particular embodiment, and the understanding of one skilled in the relevant art.

This interpretation of terminology is provided to ensure clarity and consistency throughout the specification and claims, and should not be construed as restricting the scope of the disclosed embodiments or the appended claims.

The various illustrative components, logic, logical blocks, modules, circuits, operations and algorithm processes described in connection with the embodiments disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus utilized to implement the various illustrative components, logics, logical blocks, modules, and circuits described herein may comprise, without limitation, one or more of the following: a general-purpose single-chip or multi-chip processor, a digital signal processor (DSP), an application specific integrated circuit (ASIC), a field programmable gate array (FPGA), other programmable logic devices (PLDs), discrete gate or transistor logic, discrete hardware components, or any suitable combination thereof. Such hardware and apparatus shall be configured to perform the functions described herein.

A general-purpose processor may include, but is not limited to, a microprocessor, or alternatively, any conventional processor, controller, microcontroller, or state machine. In certain implementations, a processor may be realized as a combination of computing devices. Such combinations may include, for example, a DSP and a microprocessor, a plurality of microprocessors, one or more microprocessors in conjunction with a DSP core, or any other such configuration as may be suitable for the intended application.

It is to be understood that in some embodiments, particular processes, operations, or methods may be executed by circuitry specifically designed for a given function. Such function-specific circuitry may be optimized to enhance performance, efficiency, or other relevant metrics for the particular task at hand. The selection of specific hardware implementation shall be determined based on the particular requirements of the application, which may include, inter alia, performance specifications, power consumption constraints, cost considerations, and size limitations.

Various modifications to the embodiments described in this disclosure may be readily apparent to persons having ordinary skill in the art, and the generic principles defined herein may be applied to other embodiments without departing from the spirit or scope of this disclosure. Thus, the claims are not intended to be limited to the embodiments shown herein, but are to be accorded the widest scope consistent with this disclosure, the principles and the novel features disclosed herein.

In certain implementations, the embodiments may comprise the disclosed features and may optionally include additional features not explicitly described herein. Conversely, alternative implementations may be characterized by the substantial or complete absence of non-disclosed elements. For the avoidance of doubt, it should be understood that in some embodiments, non-disclosed elements may be intentionally omitted, either partially or entirely, without departing from the scope of the invention. Such omissions of non-disclosed elements shall not be construed as limiting the breadth of the claimed subject matter, provided that the explicitly disclosed features are present in the embodiment.

Additionally, various features that are described in this specification in the context of separate embodiments also can be implemented in combination in a single implementation. Conversely, various features that are described in the context of a single implementation also can be implemented in multiple embodiments separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

The depiction of operations in a particular sequence in the drawings should not be construed as a requirement for strict adherence to that order in practice, nor should it imply that all illustrated operations must be performed to achieve the desired results. The schematic flow diagrams may represent example processes, but it should be understood that additional, unillustrated operations may be incorporated at various points within the depicted sequence. Such additional operations may occur before, after, simultaneously with, or between any of the illustrated operations.

Additionally, it should be understood that the various figures and component diagrams presented and discussed within this document are provided for illustrative purposes only and are not drawn to scale. These visual representations are intended to facilitate understanding of the described embodiments and should not be construed as precise technical drawings or limiting the scope of the invention to the specific arrangements depicted.

In certain implementations, multitasking and parallel processing may prove advantageous. Furthermore, while various system components are described as separate entities in some embodiments, this separation should not be interpreted as mandatory for all embodiments. It is contemplated that the described program components and systems may be integrated into a single software package or distributed across multiple software packages, as dictated by the specific implementation requirements.

It should be noted that other embodiments, beyond those explicitly described, fall within the scope of the appended claims. The actions specified in the claims may, in some instances, be performed in an order different from that in which they are presented, while still achieving the desired outcomes. This flexibility in execution order is an inherent aspect of the claimed processes and should be considered within the scope of the invention.

While the invention has been described in connection with certain embodiments, it will be understood by those skilled in the art that various modifications and adaptations can be made without departing from the scope of the invention. The specific embodiments presented are intended to illustrate the invention and not to limit its application or construction. Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A signal restructure unit for a radio frequency (RF) antenna system, comprising:
a first port coupled to an antenna;
a second port configured to receive second RF signals;
a third port coupled to the antenna;
a fourth port configured to receive first RF signals; and
a signal routing circuit coupled to the fourth port, the second port, the first port and the third port, and configured to:
provide in-phase restructured signals to the first port and third port when the second RF signals comprise a sum signal; and
provide anti-phase restructured signals to the first port and third port when the first RF signals comprise a difference signal.

2. The signal restructure unit of claim 1, wherein the signal routing circuit comprises a rat-race coupler.

3. The signal restructure unit of claim 2, wherein the rat-race coupler comprises at least one quarter-wavelength (λ/4) segment and at least one three-quarter-wavelength (3λ/4) segment.

4. The signal restructure unit of claim 1, wherein the signal routing circuit comprises:
a first inductive element coupled between the first port and the second port;
a second inductive element coupled between the first port and the fourth port;
a third inductive element coupled between the second port and the third port;
a first capacitive element coupled between the third port and the fourth port;
a second capacitive element coupled between the first port and a ground;
a third capacitive element coupled between the second port and the ground; and
an impedance element coupled to each of the first port, the second port, the third port and the fourth port;
wherein the first, second, and third inductive elements have substantially equal inductance, and the second and third capacitive elements each have a capacitance approximately twice that of the first capacitive element.

5. The signal restructure unit of claim 1, wherein the signal routing circuit comprises:
a substrate;
a plurality of conductive traces forming a double octagonal ring configuration coupling the fourth port, the second port, the first port, and the third port; and
a plurality of overlapping regions, each having corresponding conductive traces disposed in different layers.

6. The signal restructure unit of claim 1, wherein the antenna comprises:
a vertical radiating element having a length of approximately half-wavelength (λ/2);
a first horizontal feeding element disposed at a first location along the vertical radiating element, the first horizontal feeding element having a first feed point; and
a second horizontal feeding element disposed at a second location along the vertical radiating element, the second horizontal feeding element having a second feed point;
wherein the first port is coupled to the first feed point and the third port is coupled to the second feed point.

7. The signal restructure unit of claim 1, wherein the antenna comprises:
a first L-shaped radiating structure comprising:
a first arm extending in a vertical direction;
a second arm extending in a horizontal direction perpendicular to the vertical direction; and
a first feed point disposed at the second arm; and
a second L-shaped radiating structure comprising:
a first arm extending in a vertical direction opposite to that of the first arm of the first L-shaped radiating structure;
a second arm extending in a horizontal direction parallel to the second arm of the first L-shaped radiating structure; and
a second feed point disposed at the second arm;
wherein:
the first port is coupled to the first feed point and the third port is coupled to the second feed point;
a total length of the first arms of the first L-shaped radiating structure and the second L-shaped radiating structure is approximately λ/2; and
the first and second L-shaped radiating structures form a symmetrical structure centered about the second arms.

8. The signal restructure unit of claim 1, wherein the antenna comprises:
a vertical radiating element having a length of approximately λ/2;
a first horizontal feeding element disposed at a first location along the vertical radiating element, the first horizontal feeding element having a first feed point; and
a second horizontal feeding element disposed at a second location along the vertical radiating element, the second horizontal feeding element having a second feed point; and
a third horizontal feeding element disposed at a third location along the vertical radiating element, between the first location and the second location, the third horizontal feeding element having a third feed point;
wherein the first port is coupled to the first feed point, the third port is coupled to the second feed point, a ground is coupled to the third feed point.

9. The signal restructure unit of claim 1, wherein the antenna comprises:
a first L-shaped radiating structure disposed at a first layer, comprising:
a first arm extending in a vertical direction;
a second arm extending in a horizontal direction perpendicular to the vertical direction; and
a first feed point disposed at the second arm; and
a second L-shaped radiating structure disposed at a second layer above the first layer, the second L-shaped radiating structure comprising:
a first arm extending in a vertical direction opposite to the first arm and partially overlapping the first arm of the first L-shaped radiating structure;
a second arm extending in a horizontal direction parallel to the second arm of the first L-shaped radiating structure; and
a second feed point disposed at the second arm;
wherein:
the first port is coupled to the first feed point and the third port is coupled to the second feed point;
a total length of the first arms of the first L-shaped radiating structure and the second L-shaped radiating structure is approximately less than λ/2; and
the first and second L-shaped radiating structures form a symmetrical structure such that the second arms are positioned at opposing ends of the symmetrical structure.

10. The signal restructure unit of claim 1, wherein the antenna comprises:
a first L-shaped radiating structure, comprising:
a first arm extending in a vertical direction;
a second arm connected to the first arm and extending in a horizontal direction; and
a first feed point disposed at the second arm; and
a second L-shaped radiating structure, comprising:
a first arm extending in a vertical direction opposite to the first arm;
a second arm connected to the first arm of the second L-shaped radiating structure and parallel to the second arm of the first L-shaped radiating structure; and
a second feed point disposed at the second arm of the second L-shaped radiating structure;
wherein:
the first port is coupled to the first feed point and the third port is coupled to the second feed point;
a total length of the first arms of the first L-shaped radiating structure and the second L-shaped radiating structure is approximately greater than λ/2; and
the first and second L-shaped radiating structures form a symmetrical structure such that the second arms are positioned at opposing ends of the symmetrical structure.

11. The signal restructure unit of claim 1, wherein the antenna comprises:
a first F-shaped radiating structure, comprising:
a first arm extending in a vertical direction;
a second arm connected to the first arm and extending in a horizontal direction;
a third arm connected to the first arm and parallel to the second arm; and
a first feed point disposed at the third arm; and
a second F-shaped radiating structure, comprising:
a first arm extending in a vertical direction opposite to the first arm;
a second arm connected to the first arm of the second F-shaped radiating structure and extending in a horizontal direction;
a third arm connected to the first arm of the second F-shaped radiating structure and parallel to the second arm of the second F-shaped radiating structure; and
a second feed point disposed at the third arm;
wherein:
the first port is coupled to the first feed point and the third port is coupled to the second feed point;
a length of the first arms of the first F-shaped radiating structure and the second F-shaped radiating structure is approximately λ/4; and
the first and second F-shaped radiating structures form a symmetrical structure such that the third arms are positioned at opposing ends of the symmetrical structure.

12. A radio frequency (RF) communication system, comprising:
a digital processing circuit configured to generate and process baseband signals;
a first transceiver coupled to the digital processing circuit, and configured to convert the digital baseband signals to first RF signals and convert received first RF signals to digital baseband signals;
a second transceiver coupled to the digital processing circuit, and configured to convert the digital baseband signals to second RF signals and convert received second RF signals to digital baseband signals;
a signal restructure unit coupled to the first transceiver and the second transceiver, and configured to:
receive first RF signals from the first transceiver and second RF signals from the second transceiver; and
output restructured RF signals having at least one of in-phase relationship and anti-phase relationship;
an antenna coupled to the signal restructure unit, and configured to radiate the restructured RF signals and receive incoming RF signals.

13. The RF communication system of claim 12, wherein the signal restructure unit comprises:
a first port coupled to the antenna;
a second port configured to receive the second RF signals from the second transceiver;
a third port coupled to the antenna;
a fourth port configured to receive the first RF signals from the first transceiver; and
a signal routing circuit coupled to the fourth port, the second port, the first port and the third port, and configured to:
provide in-phase restructured signals to the first port and third port when the second RF signals comprise a sum signal; and
provide anti-phase restructured signals to the first port and third port when the first RF signals comprise a difference signal.

14. The RF communication system of claim 12, wherein the digital processing circuit comprises:
a data processor configured to process digital data;
a modulator coupled to the data processor and configured to modulate the digital data into the digital baseband signals;
a spatial processor configured to process spatial diversity signals; and
a demodulator coupled to the spatial processor and configured to demodulate received digital baseband signals into digital data;
a detection and acquisition unit configured to detect and acquire incoming signals; and
a power control unit configured to control transmission power levels.

15. The RF communication system of claim 14, wherein the digital processing circuit further comprises:
a main control unit configured to coordinate operation of the data processor, modulator, spatial processor, and demodulator;
a memory unit comprising random access memory (RAM) and read-only memory (ROM); and
wherein the main control unit is configured to execute control algorithms stored in the memory unit.

16. The RF communication system of claim 12, wherein the first transceiver and the second transceiver each comprise:
a transmitter unit configured to convert digital baseband signals to respective RF signals; and
a receiver unit configured to convert received RF signals to digital baseband signals.

17. The RF communication system of claim 16, wherein the transmitter unit and the receiver unit implement a direct-conversion architecture.

18. The RF communication system of claim 16, wherein the transmitter unit comprises:
a digital-to-analog converter (DAC) configured to convert the digital baseband signals to analog baseband signals;
a filter coupled to the DAC and configured to filter the analog baseband signals;
an amplifier coupled to the filter and configured to amplify the filtered analog baseband signals;
a mixer coupled to the amplifier and configured to convert the amplified baseband signals using a transmit local oscillator signal;
a power amplifier (PA) coupled to the mixer and configured to amplify the converted signals to generate the respective RF signals; and
an RF switch coupled between the power amplifier and the signal restructure unit.

19. The RF communication system of claim 18, wherein the signal restructure unit is positioned between the mixers and power amplifiers in the transmitter units of the first and second transceivers, and is configured to:
receive signals from the mixers of the first and second transceivers; and
provide phase-controlled signals to the power amplifiers of the first and second transceivers.

20. The RF communication system of claim 18, wherein the signal restructure unit is positioned between the amplifiers and mixers in the transmitter units of a first transceiver and a second transceiver, and is configured to:
receive signals from the amplifiers of the first and second transceivers; and
provide phase-controlled signals to the mixers of the first and second transceivers.

21. The RF communication system of claim 16, wherein the receiver unit comprises:
an RF switch coupled between the signal restructure unit and the low noise amplifier (LNA);
a low noise amplifier configured to amplify received incoming RF signals;
a mixer coupled to the LNA and configured to convert the amplified RF signals using a receive local oscillator signal;
a filter coupled to the mixer and configured to filter the converted signals;
an amplifier coupled to the filter and configured to amplify the filtered signals; and
an analog-to-digital converter (ADC) coupled to the amplifier and configured to convert the amplified analog signals to digital baseband signals.

22. The RF communication system of claim 12, further comprising another antenna coupled to the signal restructure unit, wherein the first port and the third port are coupled to another antenna.
